(19) United States
(12) Patent Application Publication
(10) Pub. No.: US 2024/0429004 A1
(43) Pub. Date: Dec. 26, 2024

(54) PRESSURE SENSITIVE SWITCH DEVICE

(71) Applicants: Chunghui KANG, Taipei City (TW); Chihkuo CHUI, Taoyuan City (TW); Jui-Ling LEE, New Taipei City (TW)

(72) Inventors: Chunghui KANG, Taipei City (TW); Chihkuo CHUI, Taoyuan City (TW); Jui-Ling LEE, New Taipei City (TW)

(21) Appl. No.: 18/748,088

(22) Filed: Jun. 20, 2024

Related U.S. Application Data
(60) Provisional application No. 63/521,948, filed on Jun. 20, 2023.

(30) Foreign Application Priority Data
Apr. 10, 2024 (CN) 202420733870.9

(51) Int. Cl. H01H 13/704; H01H 13/12

(52) U.S. Cl. CPC H01H 13/704; H01H 13/12; H01H 2203/008; H01H 2207/026; H01H 2209/074; H01H 2211/032

(57) ABSTRACT

A pressure sensitive switch device includes a first membrane, a first conductive wire, a second conductive wire, a second membrane, a pressure sensitive layer, a supporting plate, and an elastic body. The second conductive wire is disposed on the first membrane and separated from the first conductive wire. The pressure sensitive layer is disposed on the second membrane and contact to the first conductive wire and the second conductive wire. The first conductive wire is electrically connected to the second conductive wire by the pressure sensitive layer. The supporting plate is located below the first membrane and has a groove. The elastic body is located over the pressure sensitive layer. The elastic body includes a deformation portion and a protruding portion. The deformation portion is configured to generate deformation to drive the protruding portion to move.

### CROSS-REFERENCE TO RELATED APPLICATION

This application claims priority to U.S. Provisional Application Ser. No. 63/521,948 filed Jun. 20, 2023, and China Application Serial Number 202420733870.9, filed Apr. 10, 2024, the disclosures of which are incorporated herein by reference in their entireties.

### BACKGROUND

### Field of Invention

The present invention relates to a pressure sensitive switch device.

### Description of Related Art

The keys of the keyboard can be composed of Hall inductive switches, optical switches or mechanical switches. However, the mechanical switches cannot provide switch signals for other states between a pressed state and an unpressed state.

Therefore, how to propose a pressure sensitive switch device that can improve the aforementioned problem is one of the problems that the industry urgently wants to invest in research and development resources to solve.

### SUMMARY

In view of this, one purpose of the present disclosure is to provide a pressure sensitive switch device that can solve the aforementioned problems.

In order to achieve the above objective, in accordance with an embodiment of the present disclosure, a pressure sensitive switch device includes a first membrane, a first conductive wire, a second conductive wire, a second membrane, a pressure sensitive layer, a supporting plate, and an elastic body. The first conductive wire is disposed on the first membrane. The second conductive wire is disposed on the first membrane and separated from the first conductive wire. The second conductive wire is located over the first membrane. The pressure sensitive layer is disposed on the second membrane and contacts the first conductive wire and the second conductive wire. The first conductive wire is electrically connected to the second conductive wire by the pressure sensitive layer. The supporting plate is located below the first membrane. A top surface of the supporting plate has a groove. The pressure sensitive layer is in a range of the groove. The elastic body is located over the pressure sensitive layer. The elastic body includes a deformation portion and a protruding portion.

The deformation portion is located on the second membrane. The deformation portion and the second membrane form an accommodating space. The protruding portion is extended from the deformation portion and protrudes toward the pressure sensitive layer. The deformation portion is configured to generate deformation to drive the protruding portion to move in the accommodating space. The pressure sensitive layer receives a pressing force from the protruding portion to generate a switch signal corresponding to the pressing force. The switch signal is related to a variation of the pressing force.

In one or more embodiments of the present disclosure, the first conductive wire and the second conductive wire are in the same layer.

In one or more embodiments of the present disclosure, the first conductive wire, the second conductive wire, and the pressure sensitive layer are disposed between the first membrane and the second membrane.

In one or more embodiments of the present disclosure, the pressure sensitive layer is separated from the first membrane by the first conductive wire and the second conductive wire.

In one or more embodiments of the present disclosure, the elastic body further includes a fixing portion and a ring-shaped convex wall. The fixing portion is disposed on a top surface of the second membrane and is connected to the deformation portion. The fixing portion surrounds an end of the deformation portion close to the second membrane. The ring-shaped convex wall is disposed on the deformation portion and is located at an end of the deformation portion away from the second membrane. The ring-shaped convex wall is extended away from the second membrane.

In order to achieve the above objective, in accordance with an embodiment of the present disclosure, a pressure sensitive switch device includes a membrane, a first conductive wire, a second conductive wire, a pressure sensitive layer, and an elastic body. The first conductive wire is disposed on a bottom surface of the membrane. The second conductive wire is disposed on the bottom surface of the membrane and is separated from the first conductive wire. The pressure sensitive layer is disposed on the bottom surface of the membrane and is located between the first conductive wire and the second conductive wire. The pressure sensitive layer contacts the first conductive wire and the second conductive wire. The first conductive wire is electrically connected to the second conductive wire by the pressure sensitive layer. The elastic body is located over the pressure sensitive layer. The elastic body includes a deformation portion and a protruding portion. The deformation portion is located on the membrane. The deformation portion and the membrane form an accommodating space. The protruding portion is extended from the deformation portion and protrudes toward the pressure sensitive layer. The deformation portion is configured to generate deformation to drive the protruding portion to move in the accommodating space. The pressure sensitive layer receives a pressing force from the protruding portion to generate a switch signal corresponding to the pressing force. The switch signal is related to a variation of the pressing force.

In one or more embodiments of the present disclosure, the first conductive wire and the second conductive wire are in the same layer.

In one or more embodiments of the present disclosure, the pressure sensitive switch device further includes a supporting plate located below the membrane. The first conductive wire and the second conductive wire are disposed between the membrane and the supporting plate.

In one or more embodiments of the present disclosure, the first conductive wire, the second conductive wire, and the pressure sensitive layer are in the same layer.

In one or more embodiments of the present disclosure, the pressure sensitive switch device further includes a supporting plate located below the membrane. A top surface of the supporting plate has a groove. The groove is located below the first conductive wire, the second conductive wire, and the pressure sensitive layer.

In one or more embodiments of the present disclosure, the elastic body further includes a fixing portion and a ring-shaped convex wall. The fixing portion is disposed on a top surface of the membrane and is connected to the deformation portion. The fixing portion surrounds an end of the deformation portion close to the membrane. The ring-shaped convex wall is disposed on the deformation portion and is located at an end of the deformation portion away from the membrane. The ring-shaped convex wall is extended away from the membrane.

In one or more embodiments of the present disclosure, the pressure sensitive switch device further includes another membrane located below the membrane. The another membrane has a through hole located directly below the pressure sensitive layer.

In one or more embodiments of the present disclosure, the pressure sensitive switch device further includes another membrane and a supporting plate. The supporting plate is located below the membrane and the another membrane is disposed between the membrane and the supporting plate. A top surface of the supporting plate has a groove. The another membrane has a through hole located directly below the pressure sensitive layer. The through hole is located in a range of the groove.

In one or more embodiments of the present disclosure, the pressure sensitive switch device further includes another membrane located below the membrane. The first conductive wire, the second conductive wire, and the pressure sensitive layer are disposed between the membrane and the another membrane.

In one or more embodiments of the present disclosure, the pressure sensitive switch device further includes an insulating layer and a supporting plate. The supporting plate is located below the membrane and the insulating layer is disposed between the membrane and the supporting plate. A top surface of the supporting plate has a groove and the insulating layer covers the first conductive wire, the second conductive wire, and the pressure sensitive layer.

In order to achieve the above objective, in accordance with an embodiment of the present disclosure, a pressure sensitive switch device includes a membrane, a pressure sensitive layer, a first conductive wire, a second conductive wire, and an elastic body. The pressure sensitive layer is disposed on a top surface of the membrane. The first conductive wire is disposed over the membrane. The second conductive wire is disposed over the membrane and is separated from the first conductive wire. The elastic body is located over the pressure sensitive layer. The elastic body includes a deformation portion and a protruding portion. The deformation portion is located on the membrane. The deformation portion and the membrane form an accommodating space. The protruding portion is extended from the deformation portion and protrudes toward the pressure sensitive layer. The deformation portion is configured to generate deformation to drive the protruding portion to move in the accommodating space. The pressure sensitive layer receives a pressing force from the protruding portion to generate a switch signal corresponding to the pressing force. The switch signal is related to a variation of the pressing force.

In one or more embodiments of the present disclosure, the pressure sensitive layer is located between the first conductive wire and the second conductive wire and contacts the first conductive wire and the second conductive wire.

In one or more embodiments of the present disclosure, the pressure sensitive switch device further includes a supporting plate located below the membrane. The membrane is disposed between the pressure sensitive layer and the supporting plate.

In one or more embodiments of the present disclosure, the pressure sensitive layer covers the first conductive wire and the second conductive wire.

In one or more embodiments of the present disclosure, the first conductive wire and the second conductive wire are disposed on the pressure sensitive layer.

In one or more embodiments of the present disclosure, the first conductive wire, the second conductive wire, and the pressure sensitive layer are in the same layer.

In one or more embodiments of the present disclosure, the pressure sensitive switch device further includes a supporting plate located below the membrane. The supporting plate has a groove located below the pressure sensitive layer.

In one or more embodiments of the present disclosure, the pressure sensitive switch device further includes another membrane located on the membrane. The membrane has a through hole located directly below the pressure sensitive layer.

In one or more embodiments of the present disclosure, the pressure sensitive switch device further includes another membrane and a supporting plate. The supporting plate is located below the another membrane and the membrane is disposed between the another membrane and the supporting plate. A top surface of the supporting plate has a groove. The membrane has a through hole located directly below the pressure sensitive layer. The through hole is located in a range of the groove.

In one or more embodiments of the present disclosure, the pressure sensitive switch device further includes another membrane located over the membrane. The first conductive wire, the second conductive wire, and the pressure sensitive layer are disposed between the membrane and the another membrane.

In one or more embodiments of the present disclosure, the pressure sensitive switch device further includes an insulating layer and a supporting plate. The supporting plate is located below the membrane and the insulating layer is disposed over the membrane. A top surface of the supporting plate has a groove and the insulating layer covers the first conductive wire, the second conductive wire, and the pressure sensitive layer.

In summary, in the pressure sensitive switch device of the present disclosure, the deformation portion of the elastic body can receive the pressing force of the user and deform along a direction to drive the protruding portion to move, and the elastic body elastically recovers as the user no longer presses, so the user can repeatedly press the pressure sensitive switch device serving as a keyboard key. In the pressure sensitive switch device of the present disclosure, since the pressure sensitive layer includes a piezoelectric material, when the protruding portion of the elastic body is pressed toward the pressure sensitive layer, an electrical resistance value of the pressure sensitive layer will alter with the pressing force, so that a switch signal related to a variation of the pressing force can be generated when the user presses the pressure sensitive switch device. In the pressure sensitive switch device of the present disclosure, since the pressure sensitive switch device can only include two layers or even one layer of membrane, the pressure sensitive switch device can utilize a minimum quantity of membranes to simultaneously achieve the effects of saving materials and protecting wires. In the pressure sensitive switch device of the present disclosure, since the first conductive wire and the second conductive wire are in the same layer, the overall thickness of the pressure sensitive switch device can be reduced, thereby reducing the volume of the pressure sensitive switch device. In the pressure sensitive switch device of the present disclosure, since the supporting plate can have a groove, and the pressure sensitive layer is located over the groove, the pressure sensitive layer can have more space for deformation when pressed by the user, thereby improving the user's experience when the user is pressing the keyboard key. Accordingly, the pressure sensitive switch device of the present disclosure can generate switch signals between the pressed state and the unpressed state, compared with the traditional mechanical switch that can only generate all-or-nothing switch signals between the pressed state and the unpressed state, thereby increasing the flexibility and possibilities of keyboard keys in the field of e-sports.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a pressure sensitive switch device in accordance with an embodiment of the present disclosure;

FIG. 2 is a perspective cross-sectional view of the pressure sensitive switch device based on a section A-A′ of FIG. 1 in accordance with an embodiment of the present disclosure;

FIG. 3 is a cross-sectional view of the pressure sensitive switch device in accordance with an embodiment of the present disclosure;

FIG. 4 is a cross-sectional view of the pressure sensitive switch device in accordance with an embodiment of the present disclosure;

FIG. 5 is a top view of a conductive wire layer in accordance with an embodiment of the present disclosure;

FIG. 6 is a perspective view of the pressure sensitive switch device in accordance with an embodiment of the present disclosure;

FIG. 7 is a perspective cross-sectional view of the pressure sensitive switch device based on a section B-B′ of FIG. 6 in accordance with an embodiment of the present disclosure;

FIG. 8 is a cross-sectional view of the pressure sensitive switch device in accordance with an embodiment of the present disclosure;

FIG. 9 is a cross-sectional view of the pressure sensitive switch device in accordance with an embodiment of the present disclosure;

FIG. 10 is a cross-sectional view of the pressure sensitive switch device in accordance with an embodiment of the present disclosure;

FIG. 11 is a cross-sectional view of the pressure sensitive switch device in accordance with an embodiment of the present disclosure;

FIG. 12 is a cross-sectional view of the pressure sensitive switch device in accordance with an embodiment of the present disclosure;

FIG. 13 is a cross-sectional view of the pressure sensitive switch device in accordance with an embodiment of the present disclosure;

FIG. 14 is a cross-sectional view of the pressure sensitive switch device in accordance with an embodiment of the present disclosure;

FIG. 15 is a cross-sectional view of the pressure sensitive switch device in accordance with an embodiment of the present disclosure;

FIG. 16 is a cross-sectional view of the pressure sensitive switch device in accordance with an embodiment of the present disclosure;

FIG. 17 is a cross-sectional view of the pressure sensitive switch device in accordance with an embodiment of the present disclosure;

FIG. 18 is a cross-sectional view of the pressure sensitive switch device in accordance with an embodiment of the present disclosure;

FIG. 19 is a cross-sectional view of the pressure sensitive switch device in accordance with an embodiment of the present disclosure;

FIG. 20 is a cross-sectional view of the pressure sensitive switch device in accordance with an embodiment of the present disclosure;

FIG. 21 is a cross-sectional view of the pressure sensitive switch device in accordance with an embodiment of the present disclosure;

FIG. 22 is a cross-sectional view of the pressure sensitive switch device in accordance with an embodiment of the present disclosure;

FIG. 23 is a cross-sectional view of the pressure sensitive switch device in accordance with an embodiment of the present disclosure;

FIG. 24 is a cross-sectional view of the pressure sensitive switch device in accordance with an embodiment of the present disclosure;

FIG. 25 is a cross-sectional view of the pressure sensitive switch device in accordance with an embodiment of the present disclosure;

FIG. 26 is a cross-sectional view of the pressure sensitive switch device in accordance with an embodiment of the present disclosure;

FIG. 27 is a cross-sectional view of the pressure sensitive switch device in accordance with an embodiment of the present disclosure;

FIG. 28 is a cross-sectional view of the pressure sensitive switch device in accordance with an embodiment of the present disclosure;

FIG. 29 is a cross-sectional view of the pressure sensitive switch device in accordance with an embodiment of the present disclosure; and

FIG. 30 is a top view of a conductive wire layer in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a pressure sensitive switch device 100 of this embodiment and the connection relationship between the components will be described in detail.

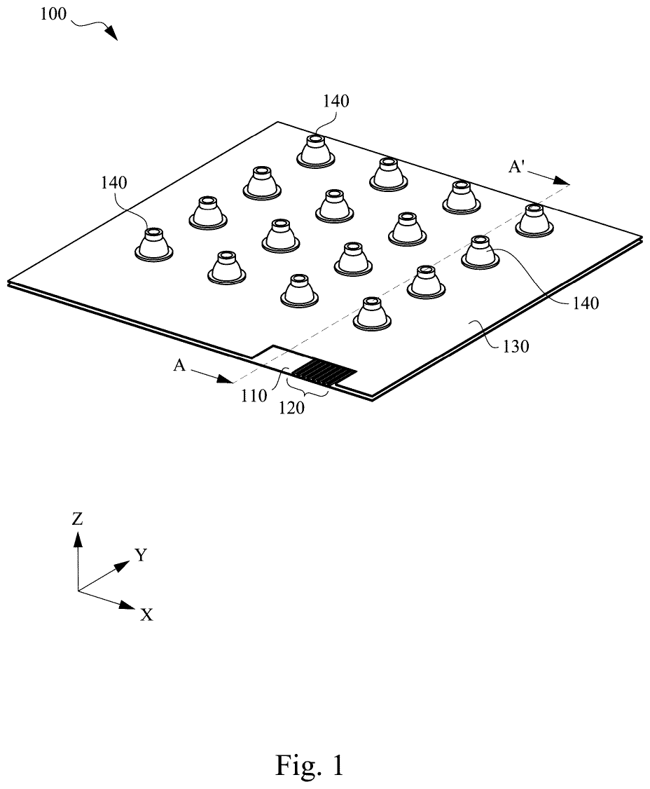

Reference is made to FIG. 1. FIG. 1 is a perspective view of a pressure sensitive switch device 100 in accordance with an embodiment of the present disclosure. As shown in FIG. 1, in this embodiment, the pressure sensitive switch device 100 includes a first membrane 110, a conductive wire layer 120, a second membrane 130, and an elastic body 140. The first membrane 110, the conductive wire layer 120, the second membrane 130, and the elastic body 140 are generally arranged along a bottom-up direction (e.g., z-direction). In some embodiments, the second membrane 130 is located over the first membrane 110. The conductive wire layer 120 is disposed between the first membrane 110 and the second membrane 130. The elastic body 140 is disposed over the conductive wire layer 120, and the elastic body 140 is configured to receive a pressing force to conduct the conductive wire layer 120 and generate a switch signal. As shown in FIG. 1, the pressure sensitive switch device 100 is depicted to include sixteen elastic bodies 140, but the present disclosure is not intended to limit the quantity of the elastic bodies 140.

In some embodiments, the pressure sensitive switch device 100 is configured as a key of a keyboard and is configured to generate a switch signal corresponding to an unpressed state and pressed state. In some embodiments, the pressure sensitive switch device 100 may be applied to, for example, a membrane keyboard or other suitable types of keyboards.

In some embodiments, the elastic body 140 is configured to accept a pressing operation of a user.

In some embodiments, materials of the first membrane 110 and the second membrane 130 may include, for example, plastic or other suitable insulating materials.

In some embodiments, a material of the conductive wire layer 120 may include, for example, metal or other suitable conductive materials.

In some embodiments, a material of the elastic body 140 may include, for example, rubber, plastic or other suitable insulating materials.

In some embodiments, the elastic body 140 may be, for example, rubber, spring, elastic sheet, foam, plastic or other suitable elastic materials.

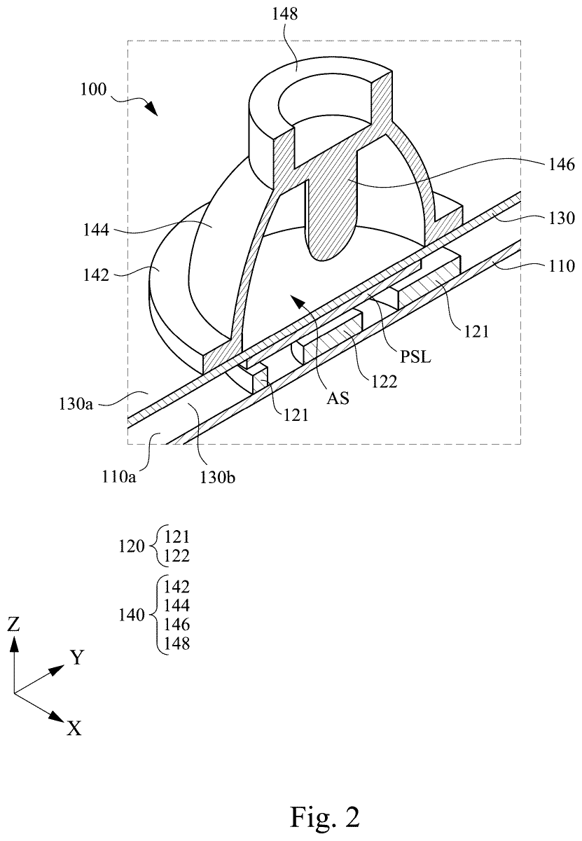

Reference is made to FIG. 2. FIG. 2 is a perspective cross-sectional view of the pressure sensitive switch device 100 based on a section A-A′ of FIG. 1 in accordance with an embodiment of the present disclosure. As shown in FIG. 2, in this embodiment, the conductive wire layer 120 includes a first conductive wire 121 and a second conductive wire 122. The first conductive wire 121 and the second conductive wire 122 are disposed on the first membrane 110, and the second conductive wire 122 is separated from the first conductive wire 121. As shown in FIG. 2, in this embodiment, the pressure sensitive switch device 100 further includes a pressure sensitive layer PSL. The pressure sensitive layer PSL is disposed on the second membrane 130. In some embodiments, the pressure sensitive layer PSL contacts the first conductive wire 121 and the second conductive wire 122, which are separated from each other, so the first conductive wire 121 can be electrically connected to the second conductive wire 122 by the pressure sensitive layer PSL. As shown in FIG. 2, the first conductive wire 121, the second conductive wire 122, and the pressure sensitive layer PSL are disposed between the first membrane 110 and the second membrane 130. This allows the first conductive wire 121, the second conductive wire 122, and the pressure sensitive layer PSL to be protected by the first membrane 110 and the second membrane 130, thereby making the conductive wire layer 120 and the pressure sensitive layer PSL last longer.

As shown in FIG. 2, in this embodiment, the elastic body 140 includes a fixing portion 142, a deformation portion 144, a protruding portion 146, and a ring-shaped convex wall 148. The fixing portion 142 is disposed on the second membrane 130. The deformation portion 144 is connected to the fixing portion 142 and located on the second membrane 130. As shown in FIG. 2, the deformation portion 144 and the second membrane 130 form an accommodating space AS. In some embodiments, the deformation portion 144 has a dome shape. As shown in FIG. 2, the fixing portion 142 surrounds an end of the deformation portion 144 close to the second membrane 130. The protruding portion 146 is extended from the deformation portion 144. The protruding portion 146 protrudes toward the pressure sensitive layer PSL. The deformation portion 144 is configured to generate deformation to drive the protruding portion 146 to move in the accommodating space AS. The ring-shaped convex wall 148 is disposed on the deformation portion 144. The ring-shaped convex wall 148 is located at an end of the deformation portion 144 away from the second membrane 130. The ring-shaped convex wall 148 is extended away from the second membrane 130. In other words, the protruding portion 146 and the ring-shaped convex wall 148 are disposed on opposite sides of a top portion of the deformation portion 144. In some embodiments, a key cap of the keyboard keys may be disposed on the ring-shaped convex wall 148. This allows the user to drive the ring-shaped convex wall 148 to move toward a direction of the pressure sensitive layer PSL by pressing the key cap, and at the same time cause the deformation portion 144 to generate the deformation.

As shown in FIG. 2, in some embodiments, the protruding portion 146 is elongated in a direction (e.g., z-direction) from an end close to the ring-shaped convex wall 148 to an end close to the second membrane 130.

As shown in FIG. 2, in some embodiments, the pressure sensitive layer PSL is separated from the first membrane 110 by the first conductive wire 121 and the second conductive wire 122.

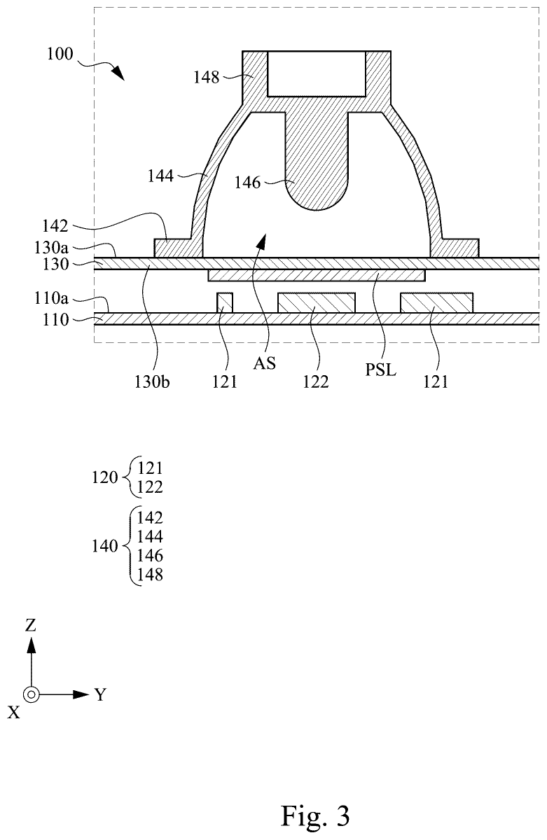

Reference is made to FIG. 3. FIG. 3 is a cross-sectional view of the pressure sensitive switch device 100 in accordance with an embodiment of the present disclosure. As shown in FIG. 3, in this embodiment, the first membrane 110 has a top surface 110a. The second membrane 130 has a top surface 130a and a bottom surface 130b. The first conductive wire 121 and the second conductive wire 122 are disposed on the top surface 110a of the first membrane 110. In some embodiments, a manufacturer can print the first conductive wire 121 and the second conductive wire 122 on the top surface 110a of the first membrane 110. The pressure sensitive layer PSL is disposed on the bottom surface 130b of the second membrane 130. The fixing portion 142 of the elastic body 140 is disposed on the top surface 130a of the second membrane 130. As shown in FIG. 3, in some embodiments, the first conductive wire 121 and the second conductive wire 122 are in the same layer. In other words, the first conductive wire 121, the second conductive wire 122, and the pressure sensitive layer PSL are arranged in a stacked manner. This allows the thickness of the pressure sensitive switch device 100 to be reduced.

How the pressure sensitive switch device 100 generates a switch signal will be described in detail below.

Reference is made again to FIG. 3. In a usage scenario, when the pressure sensitive switch device 100 is in a first state that is not pressed by the user, the protruding portion 146 does not contact the second membrane 130 and the protruding portion 146 does not apply a pressing force to the pressure sensitive layer PSL. In the first state, the pressure sensitive layer PSL, which is in contact with the first conductive wire 121 and the second conductive wire 122 at the same time, forms a loop carrying current with the first conductive wire 121 and the second conductive wire 122. Next, when the pressure sensitive switch device 100 is in a second state that is pressed by the user, the deformation portion 144 generates deformation to drive the protruding portion 146 to move in the accommodating space AS, and the protruding portion 146 contacts the second membrane 130 and applies the pressure to the pressure sensitive layer PSL. In the second state, the pressure sensitive layer PSL that simultaneously contacts the first conductive wire 121 and the second conductive wire 122 receives the pressing force from the protruding portion 146, causing the electrical resistance value of the pressure sensitive layer PSL to alter. The pressure variation caused by the aforementioned pressing force on the pressure sensitive layer PSL causes the current to alter, so as to generate a switch signal. In other words, the switch signal is related to the variation of the pressing force. Next, when the user stops pressing the pressure sensitive switch device 100 and the pressure sensitive switch device 100 returns from the second state to the first state, since the elastic body 140 has elasticity, the elastic body 140 elastically recovers to the state as shown in FIG. 3.

In a usage scenario, when the user applies a greater pressing force to the pressure sensitive layer PSL through the elastic body 140, the pressure sensitive switch device 100 can generate a switch signal corresponding to the greater pressing force. When the user applies a less pressing force to the pressure sensitive layer PSL through the elastic body 140, the pressure sensitive switch device 100 can generate a switch signal corresponding to the less pressing force. Therefore, the pressure sensitive switch device 100 of the present disclosure can generate a switch signal between all and nothing.

In some embodiments, a material of the pressure sensitive layer PSL may include, for example, a piezoelectric material, or other materials that may trigger a piezoelectric effect (piezoelectricity). In some embodiments, the pressure sensitive layer PSL may include, for example, barium titanate (BaTiO₃), lead titanate (PbTiO₃), lead zirconate titanate (PZT), lithium niobate (LiNbO₃), potassium niobate (KNbO₃), quartz (SiO₂), tourmaline, potassium sodium tartrate, zinc oxide (ZnO), or other suitable piezoelectric materials.

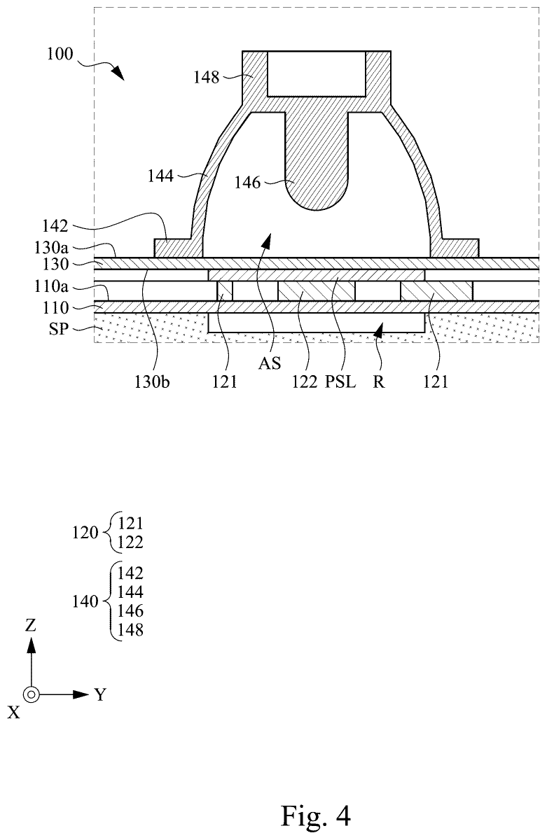

Reference is made to FIG. 4. FIG. 4 is a cross-sectional view of the pressure sensitive switch device 100 in accordance with an embodiment of the present disclosure. As shown in FIG. 4, in this embodiment, the pressure sensitive switch device 100 further includes a supporting plate SP. A top surface SPa of the supporting plate SP has a groove R. In some embodiments, the pressure sensitive layer PSL is located in a range of the groove R. This allows the pressure sensitive layer PSL to have more space for deformation when pressed by the user, thereby enhancing the user's experience when the user is pressing the keyboard keys.

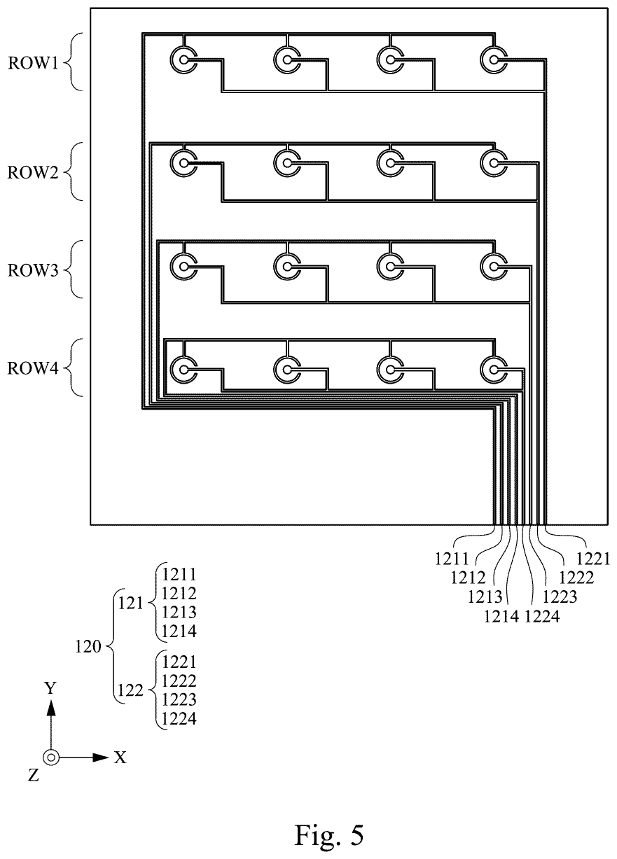

Reference is made to FIG. 5. FIG. 5 is a top view of the conductive wire layer 120 in accordance with an embodiment of the present disclosure. As shown in FIG. 5, in this embodiment, the first conductive wire 121 and the second conductive wire 122 has a circuit pattern, and the circuit pattern is distributed on a plane defined by the x-direction and the y-direction (i.e., the X-Y plane). As shown in FIG. 5, the circuit pattern formed by the first conductive wire 121 and the second conductive wire 122 is divided into a first row ROW1, a second row ROW2, a third row ROW3, and a fourth row ROW4. As shown in FIG. 5, in some embodiments, the first conductive wire 121 further includes a first sub-conductive wire 1211, a first sub-conductive wire 1212, a first sub-conductive wire 1213, and a first sub-conductive wire 1214. The second conductive wire 122 further includes a second sub-conductive wire 1221, a second sub-conductive wire 1222, a second sub-conductive wire 1223, and a second sub-conductive wire 1224. In some embodiments, the circuit pattern of the first conductive wire 121 is C-shaped. Specifically, a distributing range of a C-shaped portion of the first conductive wire 121 is configured to control a switch signal of single keyboard key. However, the present disclosure is not intended to limit the shape of the circuit pattern of the conductive wire layer 120.

As shown in FIG. 5, in this embodiment, the first sub-conductive wire 1211 and the second sub-conductive wire 1221 control the switch signal of the first row ROW1. The first sub-conductive wire 1212 and the second sub-conductive wire 1222 control the switch signal of the second row ROW2. The first sub-conductive wire 1213 and the second sub-conductive wire 1223 control the switch signal of the third row ROW3. The first sub-conductive wire 1214 and the second sub-conductive wire 1224 control the switch signal of the fourth row ROW4.

By the aforementioned structural configuration, the pressure sensitive switch device 100 can apply different extents of pressing force to the pressure sensitive layer PSL by pressing the elastic body 140 to generate the switch signal related to the aforementioned different extents of the variation of the pressing force.

Hereinafter, the structure and function of each component included in a pressure sensitive switch device 200 of this embodiment and the connection relationship between the components will be described in detail.

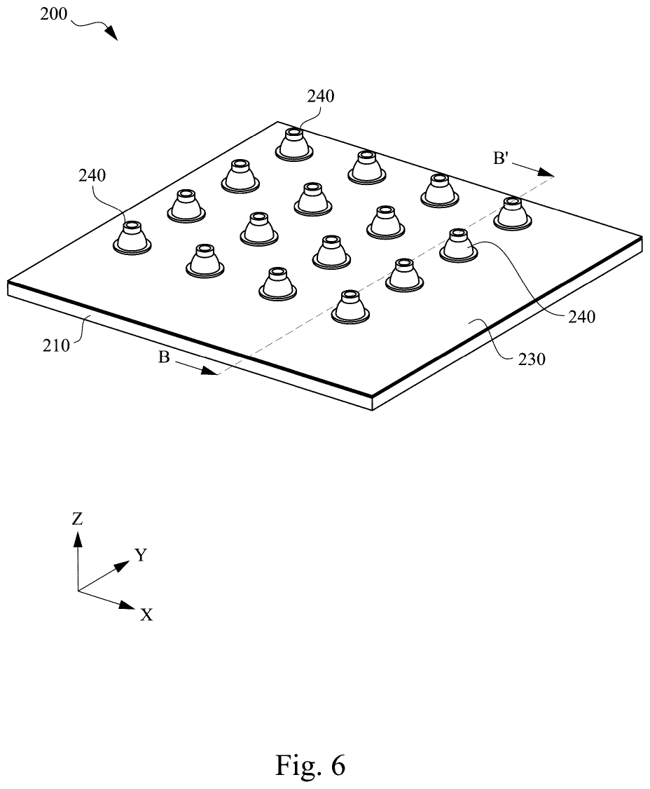

Reference is made to FIG. 6. FIG. 6 is a perspective view of a pressure sensitive switch device 200 in accordance with an embodiment of the present disclosure. As shown in FIG. 6, in this embodiment, the pressure sensitive switch device 200 includes a first membrane 210, a conductive wire layer 220, a second membrane 230, and an elastic body 240. Since the structural configuration of the pressure sensitive switch device 200 in FIG. 6 is similar to the structural configuration of the pressure sensitive switch device 100 in FIG. 1, the details will not be described again herein. As shown in FIG. 6, the pressure sensitive switch device 200 is depicted to include sixteen elastic bodies 240, but the present disclosure is not intended to limit the quantity of the elastic bodies 240.

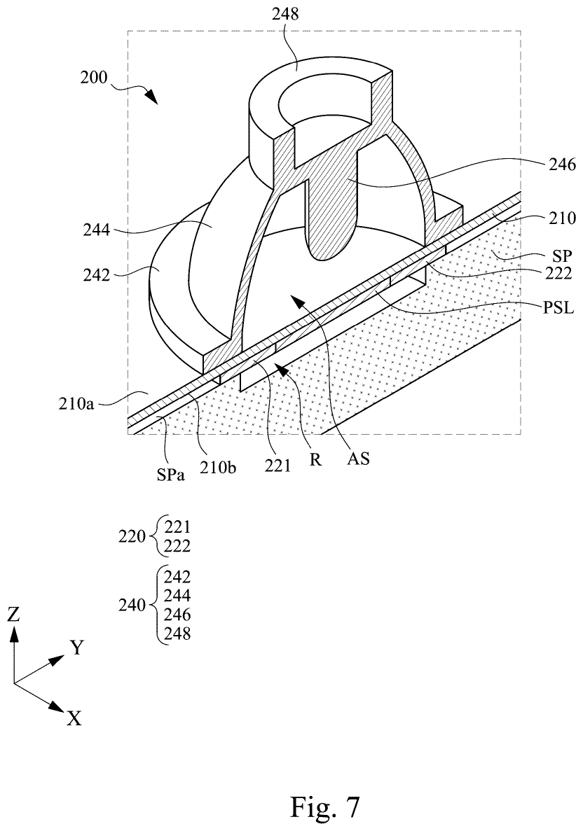

Reference is made to FIG. 7. FIG. 7 is a perspective cross-sectional view of the pressure sensitive switch device 200 based on the section B-B′ of FIG. 6 in accordance with an embodiment of the present disclosure. As shown in FIG. 7, in this embodiment, the pressure sensitive switch device 200 includes a supporting plate SP, a first membrane 210, and a conductive wire layer 220. In some embodiments, the supporting plate SP is distributed over the entire surface. The first membrane 210 is disposed over the supporting plate SP. The conductive wire layer 220 is disposed over the supporting plate SP. As shown in FIG. 7, the conductive wire layer 220 includes a first conductive wire 221 and a second conductive wire 222. The first conductive wire 221 and the second conductive wire 222 are disposed on the first membrane 210. In some embodiments, the first conductive wire 221 and the second conductive wire 222 are disposed on the bottom surface 210b of the first membrane 210. As shown in FIG. 7, in this embodiment, the pressure sensitive switch device 200 further includes a pressure sensitive layer PSL. The pressure sensitive layer PSL is disposed on the first membrane 210. In some embodiments, the pressure sensitive layer PSL is disposed on the bottom surface 210b of the first membrane 210. The pressure sensitive layer PSL is located between the first conductive wire 221 and the second conductive wire 222. The second conductive wire 222 is separated from the first conductive wire 221 by the pressure sensitive layer PSL. In some embodiments, the pressure sensitive layer PSL contacts the first conductive wire 221 and the second conductive wire 222, which are separated from each other, so the first conductive wire 221 can be electrically connected to the second conductive wire 222 through the pressure sensitive layer PSL. As shown in FIG. 2, the first conductive wire 221, the second conductive wire 222, and the pressure sensitive layer PSL are disposed between the first membrane 210 and the supporting plate SP. This allows the first conductive wire 221, the second conductive wire 222, and the pressure sensitive layer PSL to be protected by the first membrane 210 and the supporting plate SP, so as to make the conductive wire layer 220 and the pressure sensitive layer PSL last longer. As shown in FIG. 7, in this embodiment, the supporting plate SP has a groove R. The groove R is located below the first conductive wire 221, the second conductive wire 222, and the pressure sensitive layer PSL. In some embodiments, the pressure sensitive layer PSL is located in a range of the groove R. This allows the pressure sensitive layer PSL to have more space for deformation when the pressure sensitive layer PSL is pressed by the user, thereby enhancing the user's experience when the user is pressing the keyboard keys.

As shown in FIG. 7, in this embodiment, the elastic body 240 includes a fixing portion 242, a deformation portion 244, a protruding portion 246, and a ring-shaped convex wall 248. Since the structural configuration of the elastic body 240 is similar to that of the elastic body 140, the details will not be described again herein.

As shown in FIG. 7, in some embodiments, the protruding portion 246 is elongated in a direction (for example, z-direction) from an end close to the ring-shaped convex wall 248 to an end close to the second membrane 230.

As shown in FIG. 7, in some embodiments, the pressure sensitive layer PSL is separated from the supporting plate SP by a groove R.

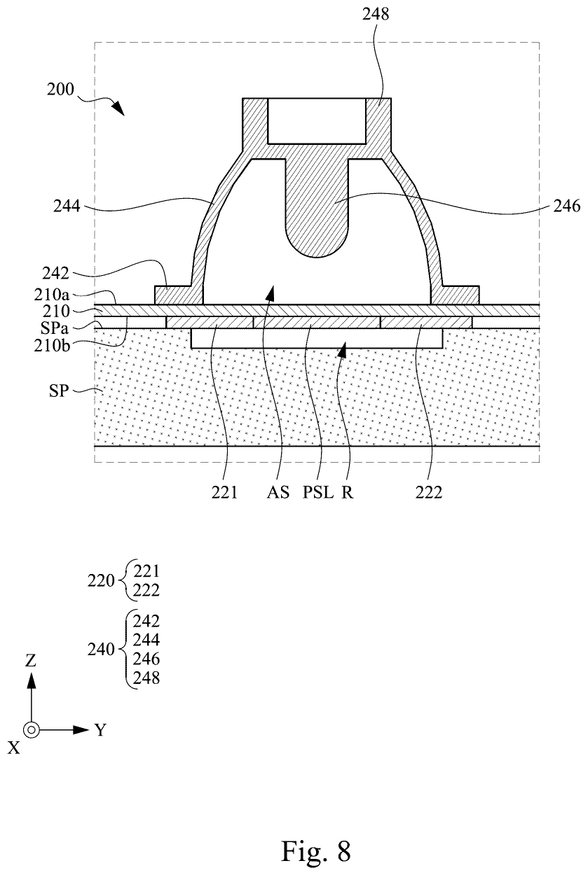

Reference is made to FIG. 8. FIG. 8 is a cross-sectional view of the pressure sensitive switch device 200 in accordance with an embodiment of the present disclosure. As shown in FIG. 8, in this embodiment, the supporting plate SP has a top surface SPa. The first membrane 210 has a top surface 210a and a bottom surface 210b. As shown in FIG. 8, the groove R of the supporting plate SP is located on the top surface SPa of the supporting plate SP. The first conductive wire 221 and the second conductive wire 222 are disposed on the bottom surface 210b of the first membrane 210. In some embodiments, the manufacturer can print the first conductive wire 221 and the second conductive wire 222 on the bottom surface 210b of the first membrane 210. The pressure sensitive layer PSL is disposed on the bottom surface 210b of the first membrane 210. The fixing portion 242 of the elastic body 240 is disposed on the top surface 210a of the first membrane 210. As shown in FIG. 8, in some embodiments, the first conductive wire 221, the second conductive wire 222, and the pressure sensitive layer PSL are in the same layer. In other words, the first conductive wire 221, the second conductive wire 222, and the pressure sensitive layer PSL are arranged side by side. This allows the thickness of the pressure sensitive switch device 200 to be reduced.

How the pressure sensitive switch device 200 generates a switch signal will be described in detail below.

Reference is made again to FIG. 8. In a usage scenario, when the pressure sensitive switch device 200 is in the first state that is not pressed by the user, the protruding portion 246 does not contact the first membrane 210 and the protruding portion 246 does not apply a pressing force to the pressure sensitive layer PSL. In the first state, the pressure sensitive layer PSL, which is in contact with the first conductive wire 221 and the second conductive wire 222 at the same time, forms a loop carrying current with the first conductive wire 221 and the second conductive wire 222. Next, when the pressure sensitive switch device 200 is in the second state that is pressed by the user, the deformation portion 244 generates deformation to drive the protruding portion 246 to move in the accommodating space AS, and the protruding portion 246 contacts the first membrane 210 and applies the pressing force to the pressure sensitive layer PSL. In the second state, the pressure sensitive layer PSL that simultaneously contacts the first conductive wire 221 and the second conductive wire 222 receives the pressing force from the protruding portion 246, causing the electrical resistance value of the pressure sensitive layer PSL to alter. The pressure variation caused by the aforementioned pressing force on the pressure sensitive layer PSL causes the current to alter, so as to generate a switch signal. In other words, the switch signal is related to the variation of the pressing force. Next, when the user stops pressing the pressure sensitive switch device 200 and the pressure sensitive switch device 200 returns from the second state to the first state, since the elastic body 240 has elasticity, the elastic body 240 elastically recovers to the state as shown in FIG. 8.

In a usage scenario, when the user applies a greater pressing force to the pressure sensitive layer PSL through the elastic body 240, the pressure sensitive switch device 200 can generate a switch signal corresponding to the greater pressing force. When the user applies a less pressing force to the pressure sensitive layer PSL through the elastic body 240, the pressure sensitive switch device 200 can generate a switch signal corresponding to the less pressing force. Therefore, the pressure sensitive switch device 200 of the present disclosure can generate a switch signal between all and nothing.

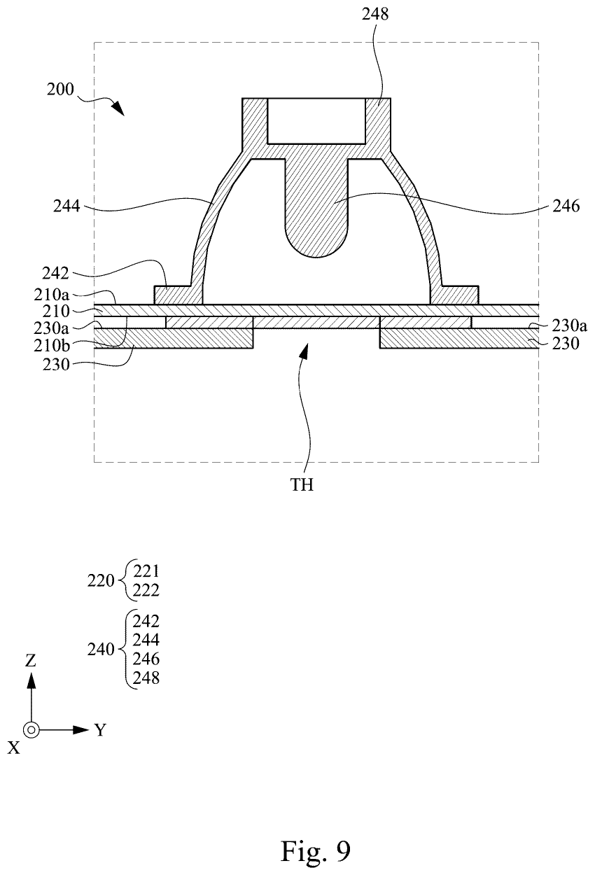

Reference is made to FIG. 9. FIG. 9 is a cross-sectional view of the pressure sensitive switch device 200 in accordance with an embodiment of the present disclosure. The structural configuration of the pressure sensitive switch device 200 in FIG. 9 is similar to the structural configuration of the pressure sensitive switch device 200 in FIG. 8. The difference in between is that the pressure sensitive switch device 200 in FIG. 9 further includes a second membrane 230 but does not include the supporting plate SP. As shown in FIG. 9, the second membrane 230 has a through hole TH located directly below the pressure sensitive layer PSL. This allows the pressure sensitive layer PSL to have more space for deformation when the pressure sensitive layer PSL is pressed by the user, thereby enhancing the user's experience when the user is pressing the keyboard keys. Since the structural configuration of the pressure sensitive switch device 200 in FIG. 9 is similar to the structural configuration of the pressure sensitive switch device 200 in FIG. 8, the details will not be described again herein.

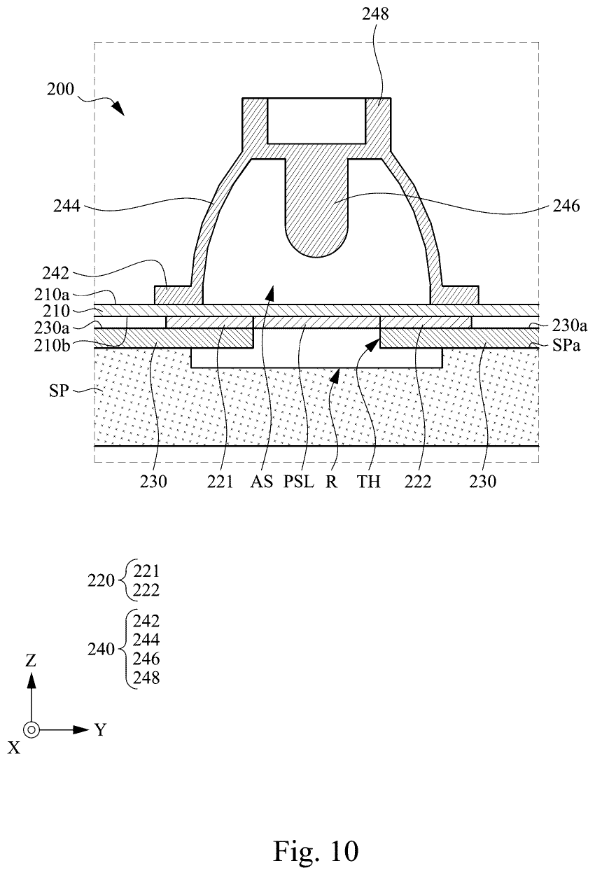

Reference is made to FIG. 10. FIG. 10 is a cross-sectional view of the pressure sensitive switch device 200 in accordance with an embodiment of the present disclosure. The structural configuration of the pressure sensitive switch device 200 in FIG. 10 is similar to the structural configuration of the pressure sensitive switch device 200 in FIG. 8. The difference in between is that the pressure sensitive switch device 200 in FIG. 10 further includes a second membrane 230. As shown in FIG. 10, the supporting plate SP is located below the first membrane 210 and the second membrane 230 is disposed between the first membrane 210 and the supporting plate SP. The top surface SPa of the supporting plate SP has a groove R. As shown in FIG. 10, the second membrane 230 has a through hole TH located directly below the pressure sensitive layer PSL. The first conductive wire 221 and the second conductive wire 222 are disposed on the top surface 230a of the second membrane 230. In some embodiments, the through hole TH are located in a range of the groove R. This allows the pressure sensitive layer PSL to have double the space for deformation when the pressure sensitive layer PSL is pressed by the user, thereby enhancing the user's experience when the user is pressing the keyboard keys. Since the structural configuration of the pressure sensitive switch device 200 in FIG. 10 is similar to the structural configuration of the pressure sensitive switch device 200 in FIG. 8, the details will not be described again herein.

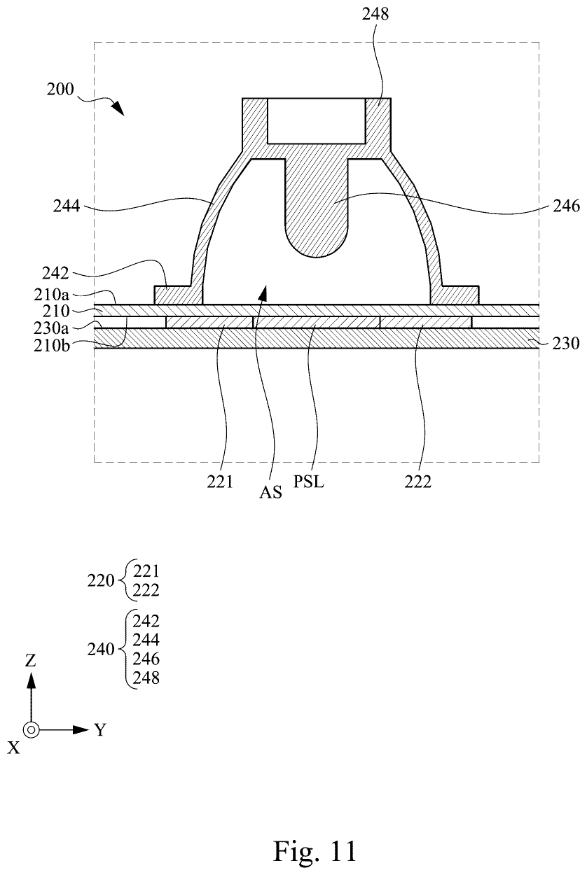

Reference is made to FIG. 11. FIG. 11 is a cross-sectional view of the pressure sensitive switch device 200 in accordance with an embodiment of the present disclosure. The structural configuration of the pressure sensitive switch device 200 in FIG. 11 is similar to the structural configuration of the pressure sensitive switch device 200 in FIG. 9. The difference in between is that the second membrane 230 of the pressure sensitive switch device 200 in FIG. 11 does not have a through hole TH. Since the structural configuration of the pressure sensitive switch device 200 in FIG. 11 is similar to the structural configuration of the pressure sensitive switch device 200 in FIG. 9, the details will not be described again herein.

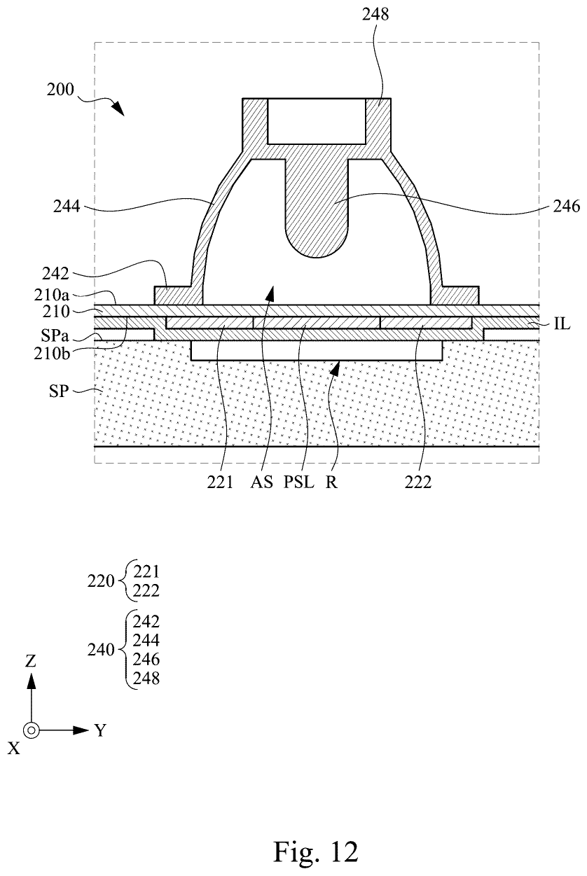

Reference is made to FIG. 12. FIG. 12 is a cross-sectional view of the pressure sensitive switch device 200 in accordance with an embodiment of the present disclosure. The structural configuration of the pressure sensitive switch device 200 in FIG. 12 is similar to the structural configuration of the pressure sensitive switch device 200 in FIG. 8. The difference in between is that the pressure sensitive switch device 200 in FIG. 12 further includes an insulating layer IL. As shown in FIG. 12, the insulating layer IL is disposed between the first membrane 210 and the supporting plate SP. As shown in FIG. 12, the insulating layer IL covers the first conductive wire 221, the second conductive wire 222, and the pressure sensitive layer PSL. This allows the pressure sensitive layer PSL to have greater space for deformation when the pressure sensitive layer PSL is pressed by the user, thereby enhancing the user's experience when the user is pressing the keyboard keys. In addition, the insulating layer IL can provide protection for the first conductive wire 221, the second conductive wire 222, and the pressure sensitive layer PSL. Since the structural configuration of the pressure sensitive switch device 200 in FIG. 12 is similar to the structural configuration of the pressure sensitive switch device 200 in FIG. 8, the details will not be described again herein.

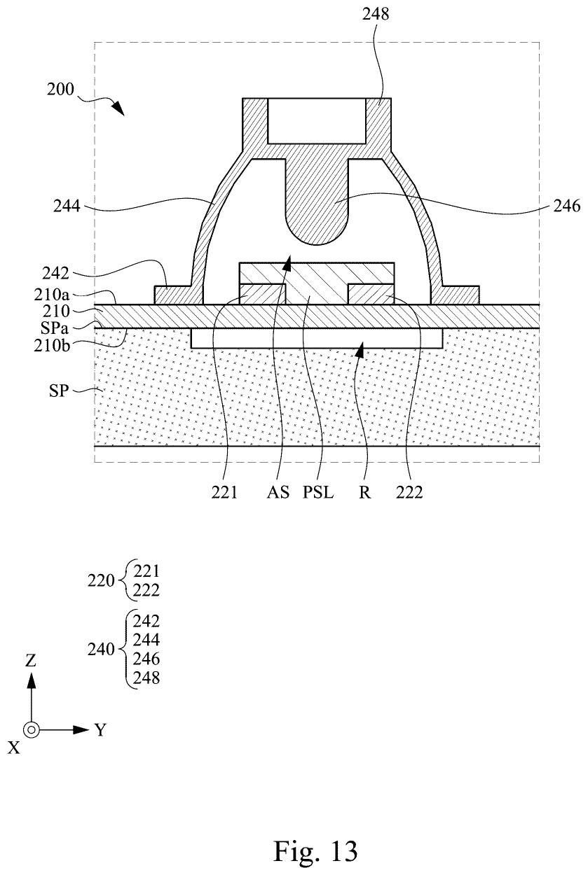

Reference is made to FIG. 13. FIG. 13 is a cross-sectional view of the pressure sensitive switch device 200 in accordance with an embodiment of the present disclosure. The structural configuration of the pressure sensitive switch device 200 in FIG. 13 is similar to the structural configuration of the pressure sensitive switch device 200 in FIG. 8. The difference in between is that the first membrane 210 shown in FIG. 13 is disposed between the pressure sensitive layer PSL and the supporting plate SP. As shown in FIG. 13, in this embodiment, the first conductive wire 221 and the second conductive wire 222 are disposed over the first membrane 210. In some embodiments, the first conductive wire 221 and the second conductive wire 222 are disposed on the top surface 210a of the first membrane 210. Moreover, the pressure sensitive layer PSL shown in FIG. 13 covers the first conductive wire 221 and the second conductive wire 222. In some embodiments, the pressure sensitive layer PSL is disposed on the first conductive wire 221 and the second conductive wire 222 and located between the first conductive wire 221 and the second conductive wire 222. In some embodiments, the groove R is located below the pressure sensitive layer PSL.

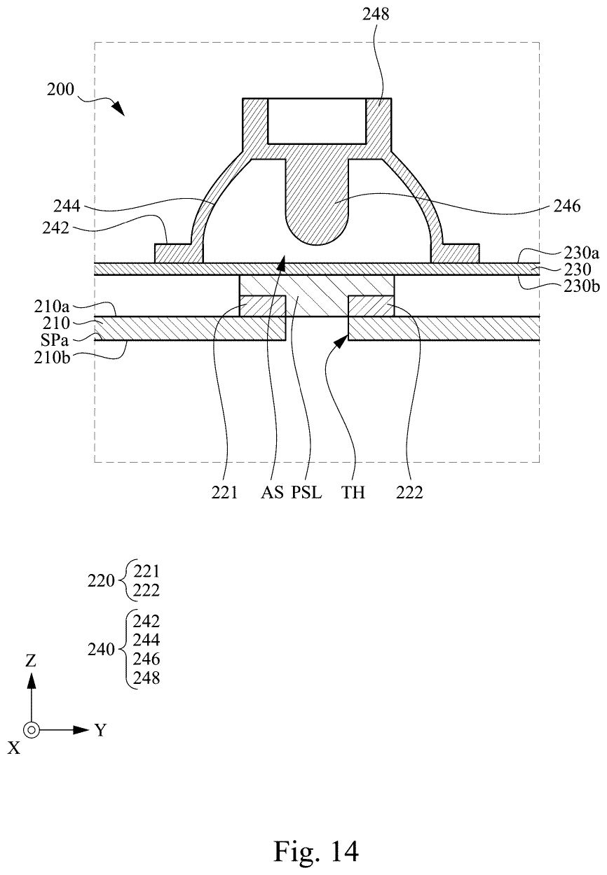

Reference is made to FIG. 14. FIG. 14 is a cross-sectional view of the pressure sensitive switch device 200 in accordance with an embodiment of the present disclosure. The structural configuration of the pressure sensitive switch device 200 in FIG. 14 is similar to the structural configuration of the pressure sensitive switch device 200 in FIG. 13. The difference in between is that the pressure sensitive switch device 200 in FIG. 14 further includes a second membrane 230 but does not include the supporting plate SP. In addition, the first membrane 210 has through hole TH. As shown in FIG. 14, the second membrane 230 is disposed over the first membrane 210. The first membrane 210 has a through hole TH located directly below the pressure sensitive layer PSL. This allows the pressure sensitive layer PSL to have more space for deformation when the pressure sensitive layer PSL is pressed by the user, thereby enhancing the user's experience when the user is pressing the keyboard keys. Since the structural configuration of the pressure sensitive switch device 200 in FIG. 14 is similar to the structural configuration of the pressure sensitive switch device 200 in FIG. 13, the details will not be described again herein.

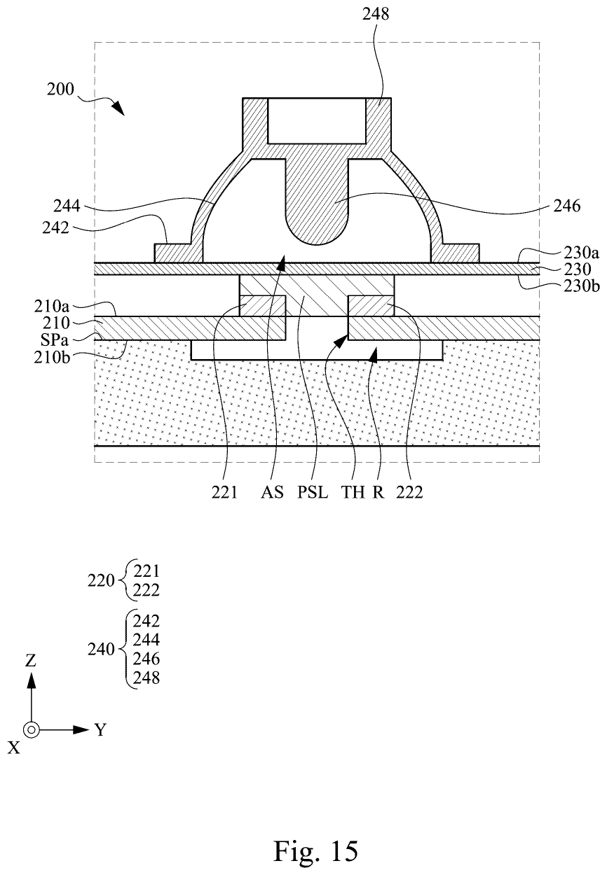

Reference is made to FIG. 15. FIG. 15 is a cross-sectional view of the pressure sensitive switch device 200 in accordance with an embodiment of the present disclosure. The structural configuration of the pressure sensitive switch device 200 in FIG. 15 is similar to the structural configuration of the pressure sensitive switch device 200 in FIG. 14. The difference in between is that the pressure sensitive switch device 200 in FIG. 15 further includes a supporting plate SP. As shown in FIG. 15, the supporting plate SP is located below the second membrane 230 and the first membrane 210 is disposed between the second membrane 230 and the supporting plate SP. The top surface SPa of the supporting plate SP has a groove R. As shown in FIG. 15, the first membrane 210 has a through hole TH located directly below the pressure sensitive layer PSL. In some embodiments, the through hole TH is located in a range of the groove R. This allows the pressure sensitive layer PSL to have double the space for deformation when the pressure sensitive layer PSL is pressed by the user, thereby enhancing the user's experience when the user is pressing the keyboard keys. Since the structural configuration of the pressure sensitive switch device 200 in FIG. 15 is similar to the structural configuration of the pressure sensitive switch device 200 in FIG. 14, the details will not be described again herein.

As shown in FIG. 15, in some embodiments, the second membrane 230 has a bottom surface 230b, and the pressure sensitive layer PSL contacts the bottom surface 230b of the second membrane 230.

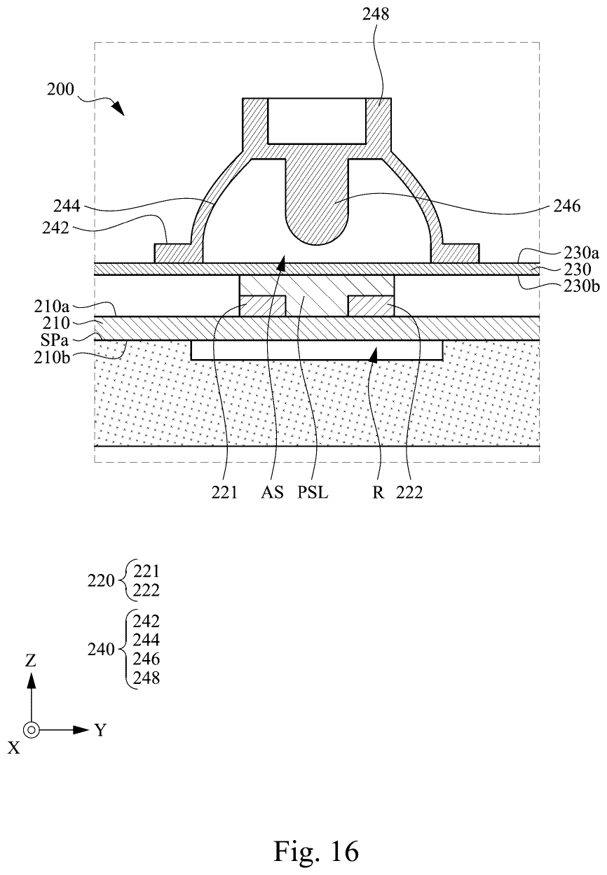

Reference is made to FIG. 16. FIG. 16 is a cross-sectional view of the pressure sensitive switch device 200 in accordance with an embodiment of the present disclosure. The structural configuration of the pressure sensitive switch device 200 in FIG. 16 is similar to the structural configuration of the pressure sensitive switch device 200 in FIG. 15. The difference in between is that the first membrane 210 of the pressure sensitive switch device 200 in FIG. 16 does not have the through hole TH. Since the structural configuration of the pressure sensitive switch device 200 in FIG. 16 is similar to the structural configuration of the pressure sensitive switch device 200 in FIG. 15, the details will not be described again herein.

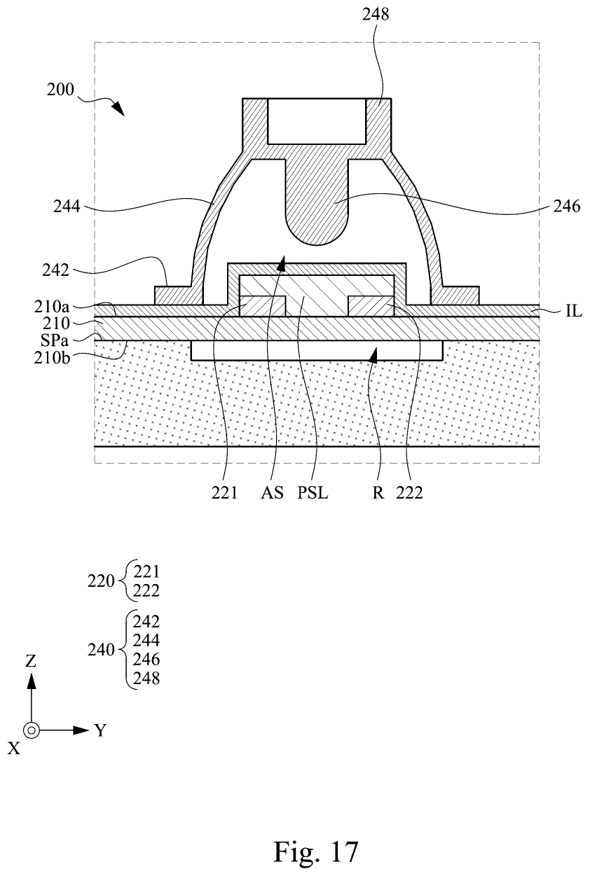

Reference is made to FIG. 17. FIG. 17 is a cross-sectional view of the pressure sensitive switch device 200 in accordance with an embodiment of the present disclosure. The structural configuration of the pressure sensitive switch device 200 in FIG. 17 is similar to the structural configuration of the pressure sensitive switch device 200 in FIG. 13. The difference in between is that the pressure sensitive switch device 200 in FIG. 17 further includes an insulating layer IL. As shown in FIG. 17, the insulating layer IL is disposed over the first membrane 210. As shown in FIG. 17, the insulating layer IL covers the first conductive wire 221, the second conductive wire 222, and the pressure sensitive layer PSL. This allows the pressure sensitive layer PSL to have greater space for deformation when the pressure sensitive layer PSL is pressed by the user, thereby enhancing the user's experience when the user is pressing the keyboard keys. In addition, the insulating layer IL can provide protection for the first conductive wire 221, the second conductive wire 222, and the pressure sensitive layer PSL. Since the structural configuration of the pressure sensitive switch device 200 in FIG. 17 is similar to the structural configuration of the pressure sensitive switch device 200 in FIG. 13, the details will not be described again herein.

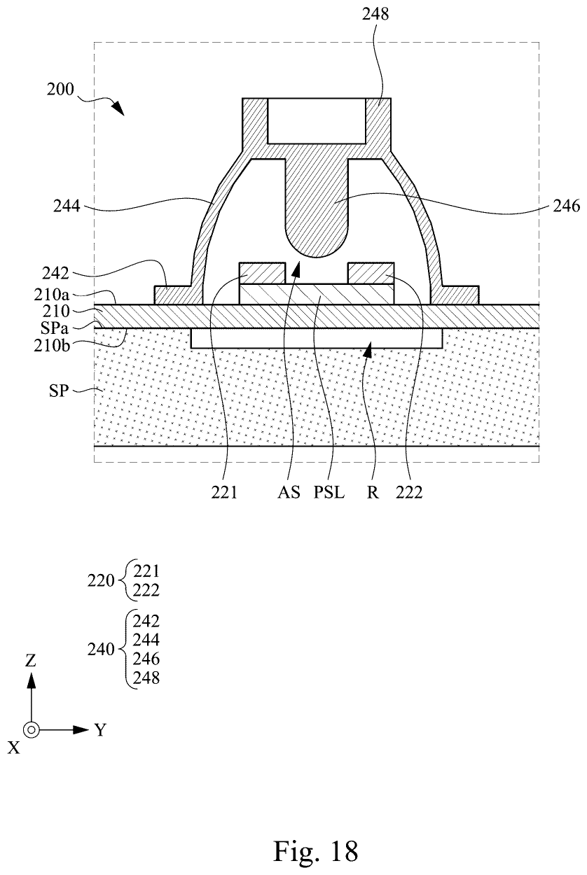

Reference is made to FIG. 18. FIG. 18 is a cross-sectional view of the pressure sensitive switch device 200 in accordance with an embodiment of the present disclosure. The structural configuration of the pressure sensitive switch device 200 in FIG. 18 is similar to the structural configuration of the pressure sensitive switch device 200 in FIG. 13. The difference in between is that the pressure sensitive layer PSL shown in FIG. 18 is located between the first membrane 210 and the conductive wire layer 220. As shown in FIG. 18, in this embodiment, the first conductive wire 221 and the second conductive wire 222 are disposed on the pressure sensitive layer PSL. In some embodiments, the first conductive wire 221 is separated from the second conductive wire 222, so that the protruding portion 246 can directly apply a pressing force to the pressure sensitive layer PSL but does not apply the pressing force to the first conductive wire 221 and the second conductive wire 222 when the user presses the pressure sensitive switch device 200.

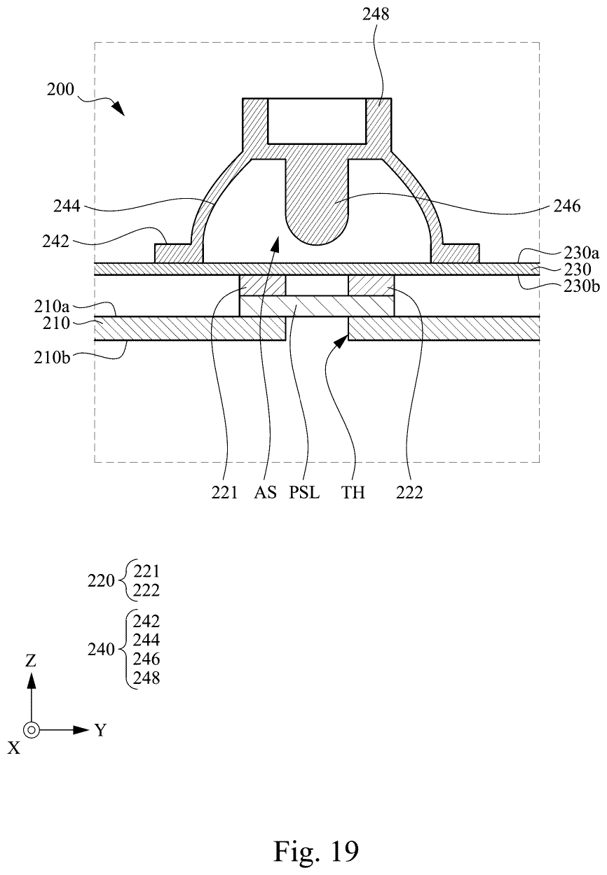

Reference is made to FIG. 19. FIG. 19 is a cross-sectional view of the pressure sensitive switch device 200 in accordance with an embodiment of the present disclosure. The structural configuration of the pressure sensitive switch device 200 in FIG. 19 is similar to the structural configuration of the pressure sensitive switch device 200 in FIG. 18. The difference in between is that the pressure sensitive switch device 200 in FIG. 19 further includes a second membrane 230 but does not include the supporting plate SP. In addition, the first membrane 210 has a through hole TH. As shown in FIG. 19, the second membrane 230 is disposed over the first membrane 210. The first membrane 210 has the through hole TH located directly below the pressure sensitive layer PSL. This allows the pressure sensitive layer PSL to have more space for deformation when the pressure sensitive layer PSL is pressed by the user, thereby enhancing the user's experience when the user is pressing the keyboard keys. Since the structural configuration of the pressure sensitive switch device 200 in FIG. 19 is similar to the structural configuration of the pressure sensitive switch device 200 in FIG. 18, the details will not be described again herein.

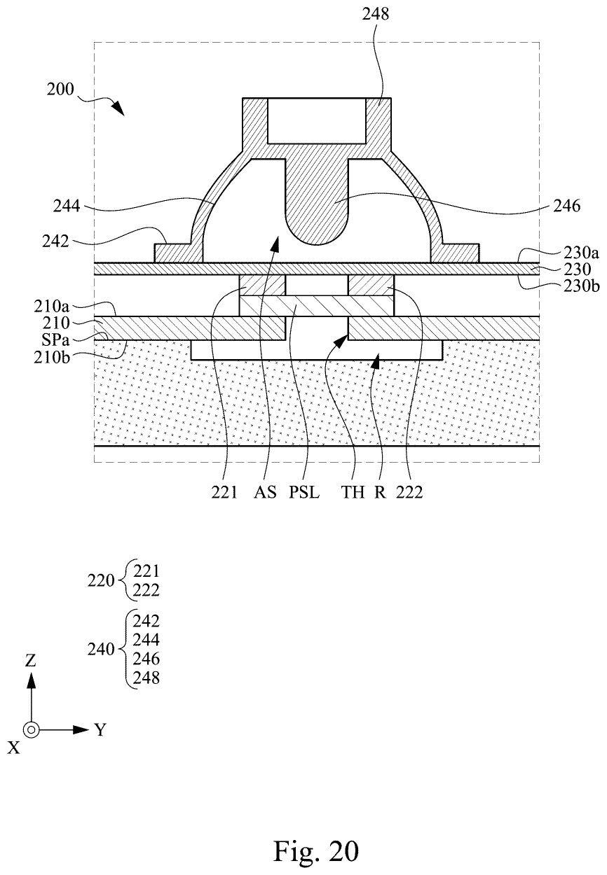

Reference is made to FIG. 20. FIG. 20 is a cross-sectional view of the pressure sensitive switch device 200 in accordance with an embodiment of the present disclosure. The structural configuration of the pressure sensitive switch device 200 in FIG. 20 is similar to the structural configuration of the pressure sensitive switch device 200 in FIG. 19. The difference in between is that the pressure sensitive switch device 200 in FIG. 20 further includes a supporting plate SP. As shown in FIG. 20, the supporting plate SP is located below the second membrane 230 and the first membrane 210 is disposed between the second membrane 230 and the supporting plate SP. The top surface SPa of the supporting plate SP has a groove R. As shown in FIG. 20, the second membrane 230 has a through hole TH located directly below the pressure sensitive layer PSL. In some embodiments, the through hole TH is located in a range of the groove R. This allows the pressure sensitive layer PSL to have double the space for deformation when the pressure sensitive layer PSL is pressed by the user, thereby enhancing the user's experience when the user is pressing the keyboard keys. Since the structural configuration of the pressure sensitive switch device 200 in FIG. 20 is similar to the structural configuration of the pressure sensitive switch device 200 in FIG. 19, the details will not be described again herein.

As shown in FIG. 20, in some embodiments, the second membrane 230 has a bottom surface 230b, and the first conductive wire 221 and the second conductive wire 222 contact the bottom surface 230b of the second membrane 230.

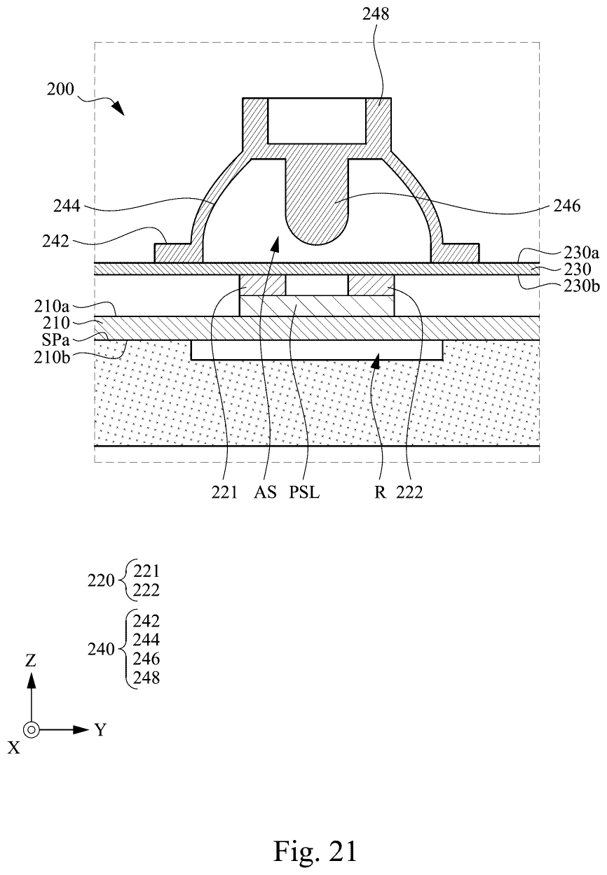

Reference is made to FIG. 21. FIG. 21 is a cross-sectional view of the pressure sensitive switch device 200 in accordance with an embodiment of the present disclosure. The structural configuration of the pressure sensitive switch device 200 in FIG. 21 is similar to the structural configuration of the pressure sensitive switch device 200 in FIG. 20. The difference in between is that the first membrane of the pressure sensitive switch device 200 in FIG. 21 210 does not have the through hole TH. Since the structural configuration of the pressure sensitive switch device 200 in FIG. 21 is similar to the structural configuration of the pressure sensitive switch device 200 in FIG. 20, the details will not be described again herein.

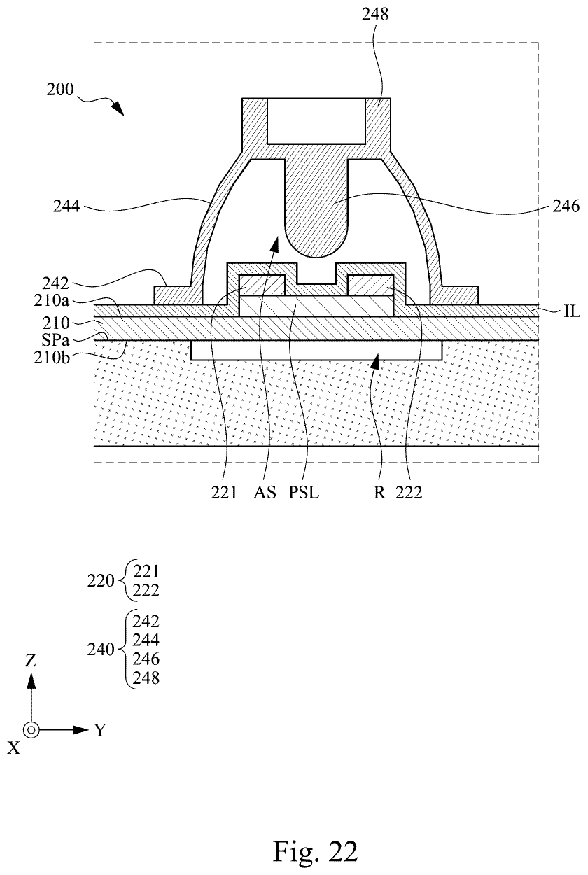

Reference is made to FIG. 22. FIG. 22 is a cross-sectional view of the pressure sensitive switch device 200 in accordance with an embodiment of the present disclosure. The structural configuration of the pressure sensitive switch device 200 in FIG. 22 is similar to the structural configuration of the pressure sensitive switch device 200 in FIG. 18. The difference in between is that the pressure sensitive switch device 200 in FIG. 22 further includes an insulating layer IL. As shown in FIG. 22, the insulating layer IL is disposed over the first membrane 210. As shown in FIG. 22, the insulating layer IL covers the first conductive wire 221, the second conductive wire 222, and the pressure sensitive layer PSL. This allows the pressure sensitive layer PSL to have greater space for deformation when the pressure sensitive layer PSL is pressed by the user, thereby enhancing the user's experience when the user is pressing the keyboard keys. In addition, the insulating layer IL can provide protection for the first conductive wire 221, the second conductive wire 222, and the pressure sensitive layer PSL. Since the structural configuration of the pressure sensitive switch device 200 in FIG. 22 is similar to the structural configuration of the pressure sensitive switch device 200 in FIG. 18, the details will not be described again herein.

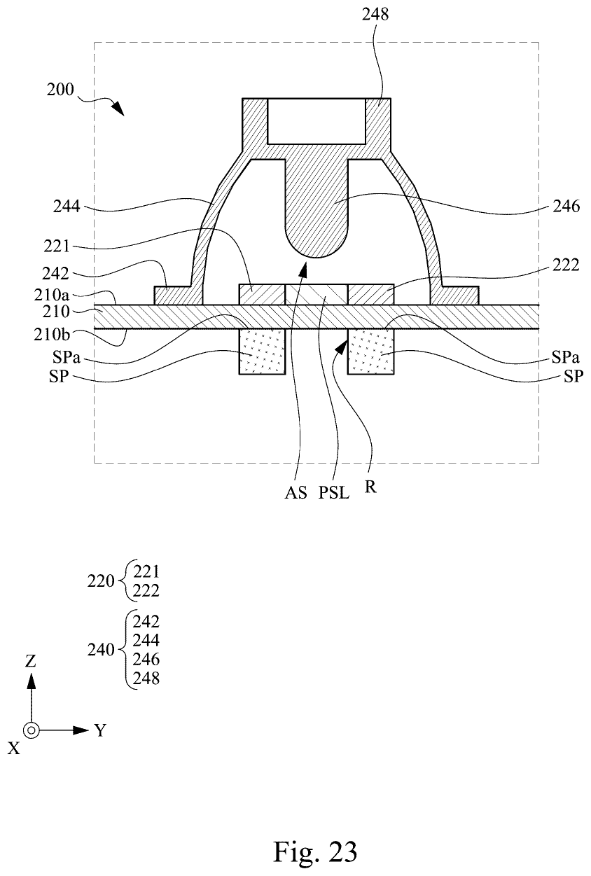

Reference is made to FIG. 23. FIG. 23 is a cross-sectional view of the pressure sensitive switch device 200 in accordance with an embodiment of the present disclosure. The structural configuration of the pressure sensitive switch device 200 in FIG. 23 is similar to the structural configuration of the pressure sensitive switch device 200 in FIG. 8. The difference in between is that the groove R shown in FIG. 23 runs through the supporting plate SP. As shown in FIG. 23, in some embodiments, the groove R is located directly below the pressure sensitive layer PSL. As shown in FIG. 23, in some embodiments, the supporting plate SP is located directly below the first conductive wire 221 and the second conductive wire 222 but not directly below the pressure sensitive layer PSL. As shown in FIG. 23, in some embodiments, the supporting plate SP is not distributed over the entire surface. Or, in some other embodiments, the supporting plate SP is distributed over the entire surface. Specifically, the supporting plate SP is not only distributed directly below the pressure sensitive layer PSL but also located directly below the pressure sensitive layer PSL.

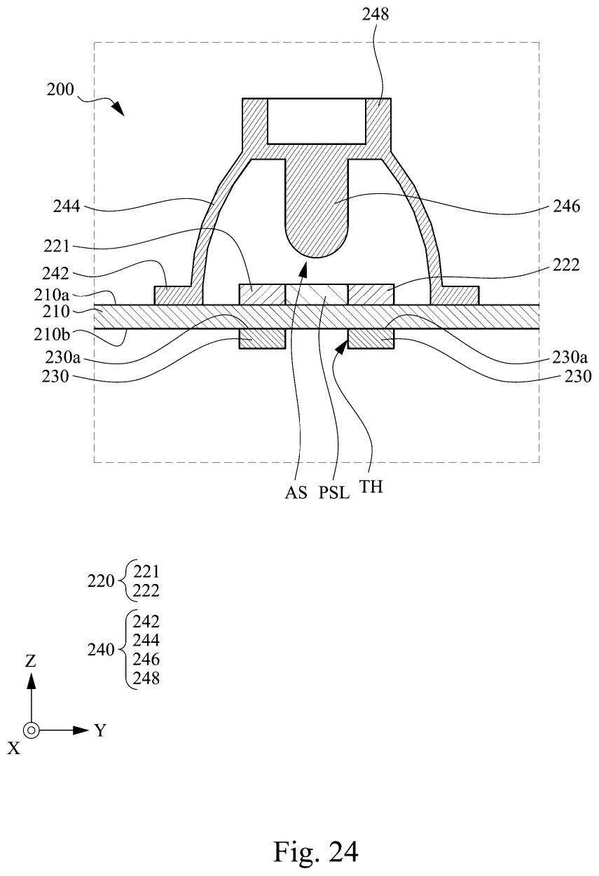

Reference is made to FIG. 24. FIG. 24 is a cross-sectional view of the pressure sensitive switch device 200 in accordance with an embodiment of the present disclosure. The structural configuration of the pressure sensitive switch device 200 in FIG. 24 is similar to the structural configuration of the pressure sensitive switch device 200 in FIG. 23. The difference in between is that the pressure sensitive switch device 200 in FIG. 24 further includes a second membrane 230 but does not include the supporting plate SP. In addition, the second membrane 230 has a through hole TH. The second membrane 230 is disposed on the first membrane 210. As shown in FIG. 24, in some embodiments, the second membrane 230 is disposed below the first membrane 210. The second membrane 230 has a through hole TH located directly below the pressure sensitive layer PSL. This allows the pressure sensitive layer PSL to have more space for deformation when the pressure sensitive layer PSL is pressed by the user, thereby enhancing the user's experience when the user is pressing the keyboard keys. Since the structural configuration of the pressure sensitive switch device 200 in FIG. 24 is similar to the structural configuration of the pressure sensitive switch device 200 in FIG. 23, the details will not be described again herein.

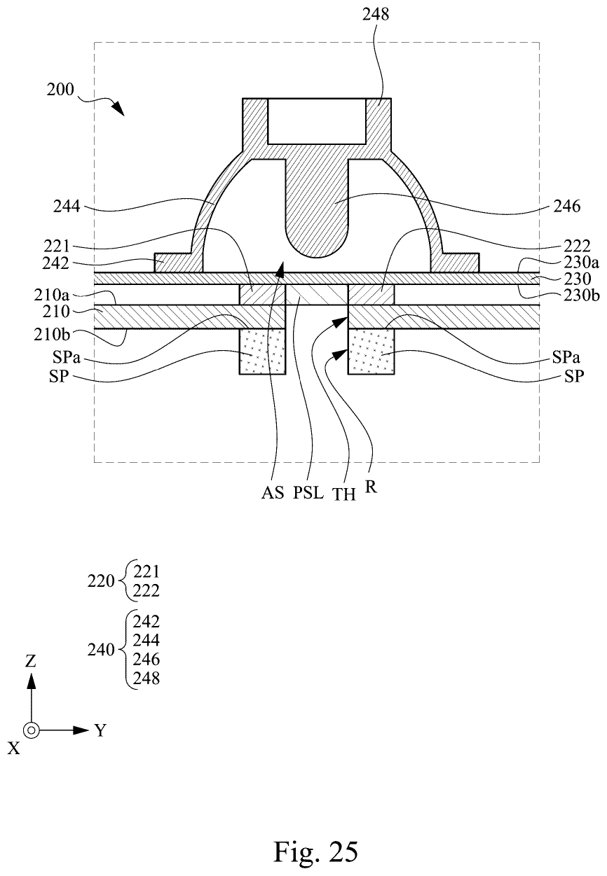

Reference is made to FIG. 25. FIG. 25 is a cross-sectional view of the pressure sensitive switch device 200 in accordance with an embodiment of the present disclosure. The structural configuration of the pressure sensitive switch device 200 in FIG. 25 is similar to the structural configuration of the pressure sensitive switch device 200 in FIG. 23. The difference in between is that the pressure sensitive switch device 200 in FIG. 25 further includes a second membrane 230 located over the supporting plate SP. In addition, the first membrane 210 has a through hole TH located directly below the pressure sensitive layer PSL. As shown in FIG. 25, the supporting plate SP is located below the second membrane 230 and the first membrane 210 is disposed between the second membrane 230 and the supporting plate SP. The top surface SPa of the supporting plate SP has a groove R. As shown in FIG. 25, in some embodiments, the through hole TH is located in a range of the groove R. This allows the pressure sensitive layer PSL to have double the space for deformation when the pressure sensitive layer PSL is pressed by the user, thereby enhancing the user's experience when the user is pressing the keyboard keys. Since the structural configuration of the pressure sensitive switch device 200 in FIG. 25 is similar to the structural configuration of the pressure sensitive switch device 200 in FIG. 23, the details will not be described again herein.

As shown in FIG. 25, in some embodiments, the second membrane 230 has a bottom surface 230b, and the first conductive wire 221, the second conductive wire 222, and the pressure sensitive layer PSL contact the bottom surface 230b of the second membrane 230.

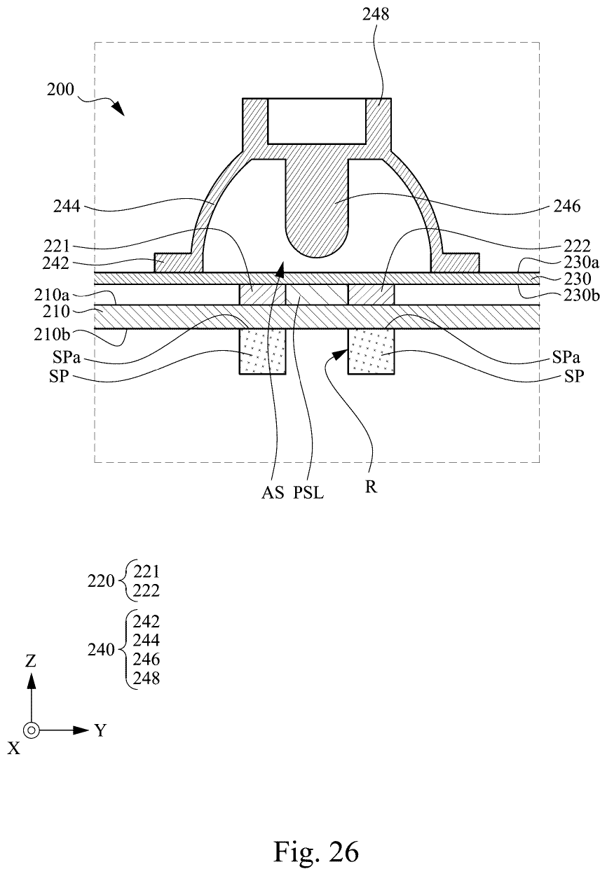

Reference is made to FIG. 26. FIG. 26 is a cross-sectional view of the pressure sensitive switch device 200 in accordance with an embodiment of the present disclosure. The structural configuration of the pressure sensitive switch device 200 in FIG. 26 is similar to the structural configuration of the pressure sensitive switch device 200 in FIG. 25. The difference in between is that the first membrane 210 of the pressure sensitive switch device 200 in FIG. 26 does not have the through hole TH. Since the structural configuration of the pressure sensitive switch device 200 in FIG. 26 is similar to the structural configuration of the pressure sensitive switch device 200 in FIG. 25, the details will not be described again herein.

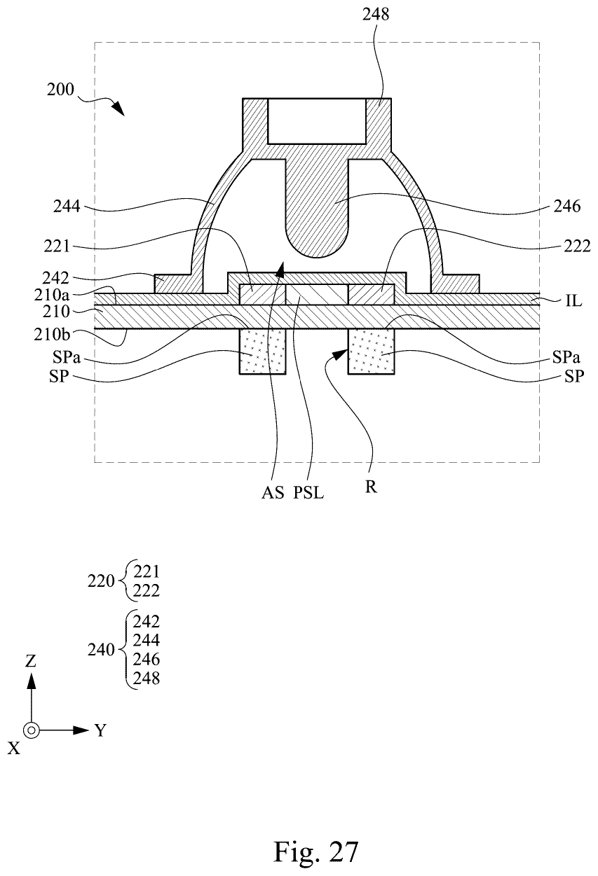

Reference is made to FIG. 27. FIG. 27 is a cross-sectional view of the pressure sensitive switch device 200 in accordance with an embodiment of the present disclosure. The structural configuration of the pressure sensitive switch device 200 in FIG. 27 is similar to the structural configuration of the pressure sensitive switch device 200 in FIG. 23. The difference in between is that the pressure sensitive switch device 200 in FIG. 27 further includes an insulating layer IL. As shown in FIG. 27, the insulating layer IL is disposed over the first membrane 210. As shown in FIG. 27, the insulating layer IL covers the first conductive wire 221, the second conductive wire 222, and the pressure sensitive layer PSL. This allows the pressure sensitive layer PSL to have greater space for deformation when the pressure sensitive layer PSL is pressed by the user, thereby enhancing the user's experience when the user is pressing the keyboard keys. In addition, the insulating layer IL can provide protection for the first conductive wire 221, the second conductive wire 222, and the pressure sensitive layer PSL. Since the structural configuration of the pressure sensitive switch device 200 in FIG. 27 is similar to the structural configuration of the pressure sensitive switch device 200 in FIG. 23, the details will not be described again herein.

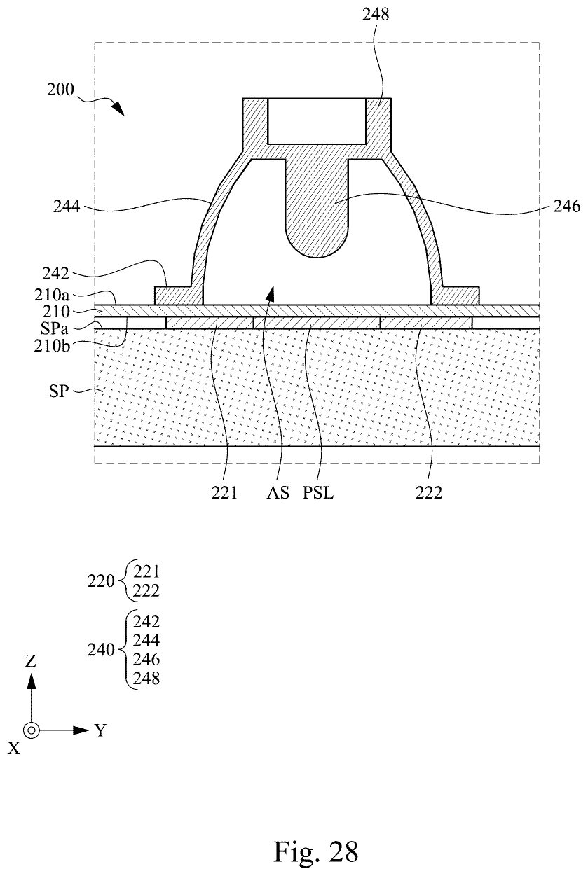

Reference is made to FIG. 28. FIG. 28 is a cross-sectional view of the pressure sensitive switch device 200 in accordance with an embodiment of the present disclosure. The structural configuration of the supporting plate SP in FIG. 28 is similar to the structural configuration of the supporting plate SP in FIG. 8. The difference in between is that the top surface SPa of the supporting plate SP in FIG. 28 does not have the groove R. In some embodiments, since the supporting plate SP in FIG. 8 has the groove R, and the supporting plate SP in FIG. 8 must simultaneously provide support for the first conductive wire 221, the second conductive wire 222, and the pressure sensitive layer PSL, a thickness of the supporting plate SP in FIG. 8 is usually greater. On the contrary, since the supporting plate SP in FIG. 28 does not have the groove R, the supporting plate SP in FIG. 28 does not need to provide the same degree of support for the first conductive wire 221, the second conductive wire 222, and the pressure sensitive layer PSL as the supporting plate SP in FIG. 8, so a thickness of the supporting plate SP in FIG. 28 is usually less. In other words, in some embodiments, the thickness of the supporting plate SP without the groove R is less than the thickness of the supporting plate SP with the groove R.

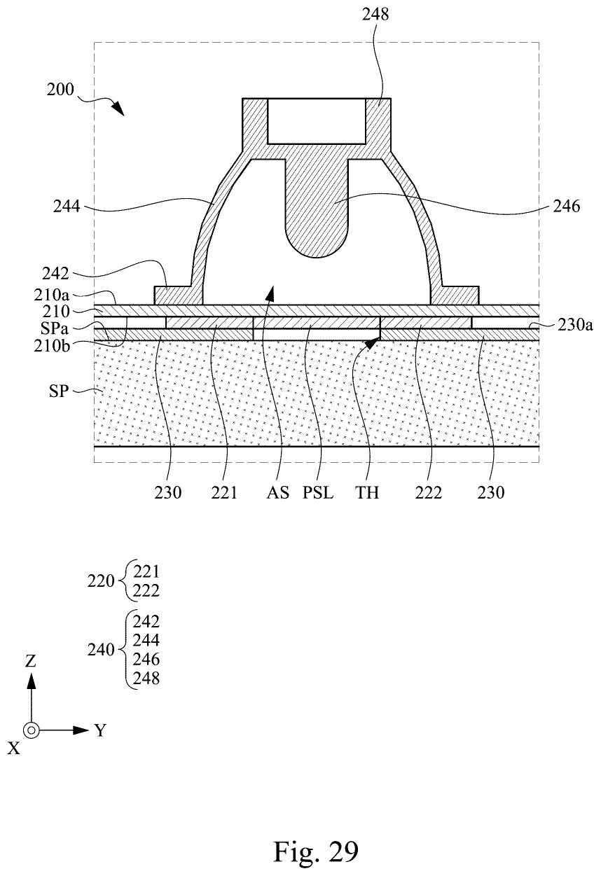

Reference is made to FIG. 29. FIG. 29 is a cross-sectional view of the pressure sensitive switch device 200 in accordance with an embodiment of the present disclosure. The structural configuration of the pressure sensitive switch device 200 in FIG. 29 is similar to the structural configuration of the pressure sensitive switch device 200 in FIG. 28. The difference in between is that the pressure sensitive switch device 200 in FIG. 29 further includes a second membrane 230 located below the first membrane 210. In addition, the second membrane 230 has a through hole TH located directly below the pressure sensitive layer PSL. As shown in FIG. 29, the second membrane 230 is disposed between the first membrane 210 and the supporting plate SP. This allows the pressure sensitive layer PSL to have greater space for deformation when the pressure sensitive layer PSL is pressed by the user, thereby enhancing the user's experience when the user is pressing the keyboard keys. Since the structural configuration of the pressure sensitive switch device 200 in FIG. 29 is similar to the structural configuration of the pressure sensitive switch device 200 in FIG. 28, the details will not be described again herein.

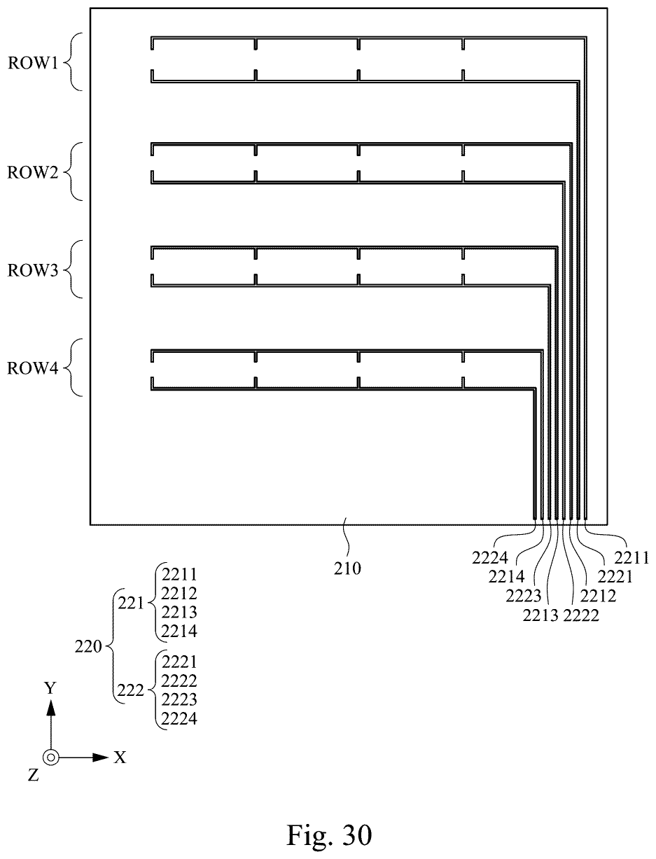

Reference is made to FIG. 30. FIG. 30 is a top view of the conductive wire layer 220 in accordance with an embodiment of the present disclosure. As shown in FIG. 30, in this embodiment, the conductive wire layer 220 has a circuit pattern different from that of the conductive wire layer 120. As shown in FIG. 30, the circuit pattern formed by the first conductive wire 221 and the second conductive wire 222 is divided into a first row ROW1, a second row ROW2, a third row ROW3, and a fourth row ROW4. As shown in FIG. 30, in some embodiments, the first conductive wire 221 further includes a first sub-conductive wire 2211, a first sub-conductive wire 2212, a first sub-conductive wire 2213, and a first sub-conductive wire 2214. The second conductive wire 222 further includes a second sub-conductive wire 2221, a second sub-conductive wire 2222, a second sub-conductive wire 2223, and a second sub-conductive wire 2224. However, the present disclosure is not intended to limit the shape of the circuit pattern of the conductive wire layer 220.

As shown in FIG. 30, in this embodiment, the first sub-conductive wire 2211 and the second sub-conductive wire 2221 control the switch signal of the first row ROW1. The first sub-conductive wire 2212 and the second sub-conductive wire 2222 control the switch signal of the second row ROW2. The first sub-conductive wire 2213 and the second sub-conductive wire 2223 control the switch signal of the third row ROW3. The first sub-conductive wire 2214 and the second sub-conductive wire 2224 control the switch signal of the fourth row ROW4.

By the aforementioned structural configuration, the pressure sensitive switch device 200 can apply different extents of pressing force to the pressure sensitive layer PSL by pressing the elastic body 240 to generate the switch signal related to the aforementioned different extents of the variation of the pressing force.

Reference is made again to FIG. 2 to FIG. 4. In some embodiments, the manufacturer may print the first conductive wire 121 and the second conductive wire 122 priorly, and then print the pressure sensitive layer PSL. In some other embodiments, the manufacturer may print the pressure sensitive layer PSL priorly, and then print the first conductive wire 121 and the second conductive wire 122. The present disclosure is not intended to limit the printing order of the first conductive wire 121, the second conductive wire 122, and the pressure sensitive layer PSL.

Reference is made again to FIG. 7 to FIG. 29. In some embodiments, the manufacturer may print the first conductive wires 221 and the second conductive wires 222 priorly, and then print the pressure sensitive layer PSL. In some other embodiments, the manufacturer may print the pressure sensitive layer PSL priorly, and then print the first conductive wire 221 and the second conductive wire 222. The present disclosure is not intended to limit the printing order of the first conductive wire 221, the second conductive wire 222, and the pressure sensitive layer PSL.

From the above detailed description of the specific embodiments of the present disclosure, it can be clearly seen that in the pressure sensitive switch device of the present disclosure, the deformation portion of the elastic body can receive the pressing force of the user and deform along a direction to drive the protruding portion to move, and the elastic body elastically recovers as the user no longer presses, so the user can repeatedly press the pressure sensitive switch device serving as a keyboard key. In the pressure sensitive switch device of the present disclosure, since the pressure sensitive layer includes a piezoelectric material, when the protruding portion of the elastic body is pressed toward the pressure sensitive layer, an electrical resistance value of the pressure sensitive layer will alter with the pressing force, so that a switch signal related to a variation of the pressing force can be generated when the user presses the pressure sensitive switch device. In the pressure sensitive switch device of the present disclosure, since the pressure sensitive switch device can only include two layers or even one layer of membrane, the pressure sensitive switch device can utilize a minimum quantity of membranes to simultaneously achieve the effects of saving materials and protecting wires. In the pressure sensitive switch device of the present disclosure, since the first conductive wire and the second conductive wire are in the same layer, the overall thickness of the pressure sensitive switch device can be reduced, thereby reducing the volume of the pressure sensitive switch device. In the pressure sensitive switch device of the present disclosure, since the supporting plate can have a groove, and the pressure sensitive layer is located over the groove, the pressure sensitive layer can have more space for deformation when pressed by the user, thereby improving the user's experience when the user is pressing the keyboard key. Accordingly, the pressure sensitive switch device of the present disclosure can generate switch signals between the pressed state and the unpressed state, compared with the traditional mechanical switch that can only generate all-or-nothing switch signals between the pressed state and the unpressed state, thereby increasing the flexibility and possibilities of keyboard keys in the field of e-sports.

Although the present disclosure has been described in considerable detail with reference to certain embodiments thereof, other embodiments are possible. Therefore, the spirit and scope of the appended claims should not be limited to the description of the embodiments contained herein.

What is claimed is:

1. A pressure sensitive switch device, comprising:
a first membrane;
a first conductive wire disposed on the first membrane;
a second conductive wire disposed on the first membrane and separated from the first conductive wire;
a second membrane located over the first membrane;
a pressure sensitive layer disposed on the second membrane and contacting the first conductive wire and the second conductive wire, and the first conductive wire being electrically connected to the second conductive wire by the pressure sensitive layer;
a supporting plate located below the first membrane, and a top surface of the supporting plate having a groove, wherein the pressure sensitive layer is in a range of the groove; and
an elastic body located over the pressure sensitive layer, comprising:
a deformation portion located on the second membrane, and the deformation portion and the second membrane forming an accommodating space; and
a protruding portion extended from the deformation portion and protruding toward the pressure sensitive layer, and the deformation portion being configured to generate deformation to drive the protruding portion to move in the accommodating space,
wherein the pressure sensitive layer receives a pressing force from the protruding portion to generate a switch signal corresponding to the pressing force, and the switch signal is related to a variation of the pressing force.

2. The pressure sensitive switch device of claim 1, wherein the first conductive wire and the second conductive wire are in the same layer.

3. The pressure sensitive switch device of claim 1, wherein the first conductive wire, the second conductive wire, and the pressure sensitive layer are disposed between the first membrane and the second membrane.

4. The pressure sensitive switch device of claim 1, wherein the pressure sensitive layer is separated from the first membrane by the first conductive wire and the second conductive wire.

5. The pressure sensitive switch device of claim 1, wherein the elastic body further comprises:
a fixing portion disposed on a top surface of the second membrane and connected to the deformation portion, and the fixing portion surrounding an end of the deformation portion close to the second membrane; and
a ring-shaped convex wall disposed on the deformation portion and located at an end of the deformation portion away from the second membrane, and the ring-shaped convex wall being extended away from the second membrane.

6. A pressure sensitive switch device, comprising:
a membrane;
a first conductive wire disposed on a bottom surface of the membrane;
a second conductive wire disposed on the bottom surface of the membrane and separated from the first conductive wire;
a pressure sensitive layer disposed on the bottom surface of the membrane and located between the first conductive wire and the second conductive wire, wherein the pressure sensitive layer contacts the first conductive wire and the second conductive wire, and the first conductive wire is electrically connected to the second conductive wire by the pressure sensitive layer; and
an elastic body located over the pressure sensitive layer, comprising:
a deformation portion located on the membrane, and the deformation portion and the membrane forming an accommodating space; and
a protruding portion extended from the deformation portion and protruding toward the pressure sensitive layer, and the deformation portion being configured to generate deformation to drive the protruding portion to move in the accommodating space,
wherein the pressure sensitive layer receives a pressing force from the protruding portion to generate a switch signal corresponding to the pressing force, and the switch signal is related to a variation of the pressing force.

7. The pressure sensitive switch device of claim 6, wherein the first conductive wire and the second conductive wire are in the same layer.

8. The pressure sensitive switch device of claim 6, further comprising a supporting plate located below the membrane, and the first conductive wire and the second conductive wire being disposed between the membrane and the supporting plate.

9. The pressure sensitive switch device of claim 6, wherein the first conductive wire, the second conductive wire, and the pressure sensitive layer are in the same layer.

10. The pressure sensitive switch device of claim 6, further comprising a supporting plate located below the membrane, a top surface of the supporting plate having a groove, and the groove being located below the first conductive wire, the second conductive wire, and the pressure sensitive layer.

11. The pressure sensitive switch device of claim 6, wherein the elastic body further comprises:
a fixing portion disposed on a top surface of the membrane and connected to the deformation portion, and the fixing portion surrounding an end of the deformation portion close to the membrane; and
a ring-shaped convex wall disposed on the deformation portion and located at an end of the deformation portion away from the membrane, and the ring-shaped convex wall being extended away from the membrane.

12. The pressure sensitive switch device of claim 6, further comprising another membrane located below the membrane, and the another membrane having a through hole located directly below the pressure sensitive layer.

13. The pressure sensitive switch device of claim 6, further comprising another membrane and a supporting plate, wherein the supporting plate is located below the membrane and the another membrane is disposed between the membrane and the supporting plate, and wherein a top surface of the supporting plate has a groove, and wherein the another membrane has a through hole located directly below the pressure sensitive layer, and the through hole is located in a range of the groove.

14. The pressure sensitive switch device of claim 6, further comprising another membrane located below the membrane, and the first conductive wire, the second conductive wire, and the pressure sensitive layer being disposed between the membrane and the another membrane.

15. The pressure sensitive switch device of claim 6, further comprising an insulating layer and a supporting plate, wherein the supporting plate is located below the membrane and the insulating layer is disposed between the membrane and the supporting plate, and wherein a top surface of the supporting plate has a groove and the insulating layer covers the first conductive wire, the second conductive wire, and the pressure sensitive layer.

16. A pressure sensitive switch device, comprising:
a membrane;
a pressure sensitive layer disposed on a top surface of the membrane;
a first conductive wire disposed over the membrane;
a second conductive wire disposed over the membrane and separated from the first conductive wire; and
an elastic body located over the pressure sensitive layer, comprising:
a deformation portion located on the membrane, and the deformation portion and the membrane forming an accommodating space; and
a protruding portion extended from the deformation portion and protruding toward the pressure sensitive layer, and the deformation portion being configured to generate deformation to drive the protruding portion to move in the accommodating space,
wherein the pressure sensitive layer receives a pressing force from the protruding portion to generate a switch signal corresponding to the pressing force, and the switch signal is related to a variation of the pressing force.

17. The pressure sensitive switch device of claim 16, wherein the pressure sensitive layer is located between the first conductive wire and the second conductive wire and contacts the first conductive wire and the second conductive wire.

18. The pressure sensitive switch device of claim 16, further comprising a supporting plate located below the membrane, and the membrane being disposed between the pressure sensitive layer and the supporting plate.

19. The pressure sensitive switch device of claim 16, wherein the pressure sensitive layer covers the first conductive wire and the second conductive wire.

20. The pressure sensitive switch device of claim 16, wherein the first conductive wire and the second conductive wire are disposed on the pressure sensitive layer.

21. The pressure sensitive switch device of claim 16, wherein the first conductive wire, the second conductive wire, and the pressure sensitive layer are in the same layer.

22. The pressure sensitive switch device of claim 16, further comprising a supporting plate located below the membrane, and the supporting plate having a groove located below the pressure sensitive layer.

23. The pressure sensitive switch device of claim 16, further comprising another membrane located on the membrane, and the membrane having a through hole located directly below the pressure sensitive layer.

24. The pressure sensitive switch device of claim 16, further comprising another membrane and a supporting plate, wherein the supporting plate is located below the another membrane and the membrane is disposed between the another membrane and the supporting plate, and wherein a top surface of the supporting plate has a groove, and wherein the membrane has a through hole located directly below the pressure sensitive layer, and the through hole is located in a range of the groove.

25. The pressure sensitive switch device of claim 16, further comprising another membrane located over the membrane, and the first conductive wire, the second conductive wire, and the pressure sensitive layer being disposed between the membrane and the another membrane.

26. The pressure sensitive switch device of claim 16, further comprising an insulating layer and a supporting plate, wherein the supporting plate is located below the membrane and the insulating layer is disposed over the membrane, and wherein a top surface of the supporting plate has a groove and the insulating layer covers the first conductive wire, the second conductive wire, and the pressure sensitive layer.
